(19) United States
(12) Patent Application Publication
(10) Pub. No.: US 2015/0120633 A1
(43) Pub. Date: Apr. 30, 2015

(54) WELLNESS INFORMATION ANALYSIS SYSTEM

(71) Applicant: Health 123, Inc., Seattle, WA (US)

(72) Inventors: Rebecca Norlander, Seattle, WA (US); Rachel Lanham, Seattle, WA (US); Sara de la Torre, Seattle, WA (US); Betsy Speare, Seattle, WA (US); Peter Schmidt, Seattle, WA (US); Tim Muss, Seattle, WA (US)

(21) Appl. No.: 14/530,233

(22) Filed: Oct. 31, 2014

Related U.S. Application Data
(60) Provisional application No. 61/898,180, filed on Oct. 31, 2013.

(51) Int. Cl. G06N 5/04

(52) U.S. Cl. CPC G06N 5/04
USPC 706/46

(57) ABSTRACT

A method that includes receiving information related to a wellness of a user from a plurality of data sources associated with the user, generating a wellness rating for the user, the generating of the wellness rating being based in part on the received information and based further in part on one or more weighting factors applied to the received information, and providing to the user an indication of the generated wellness rating and recommendations for improving the wellness of the user. At a time subsequent to the providing, receiving additional information related to the wellness of the user from at least one of the plurality of data sources associated with the user and generating, based at least in part on the receiving of the additional information, a modified wellness rating for the user.

### TECHNICAL FIELD

The following disclosure relates generally to techniques for facilitating the integration, analysis and presentation of various types of information related to the wellness of individuals and groups.

### BACKGROUND

Over the last several years, people have increasingly turned to the Internet for medical and health-related information, including to identify, learn about and track aspects of their own wellness. As one example, various fitness- and health-related services have started offering Web sites and mechanisms for tracking aspects of an individual user's health, such as diet and/or exercise plans targeted at improving the overall wellness of those individuals pursuing such plans. In addition, various medical providers and health insurance providers offer ways for their respective members to electronically interact with those providers in order to view or contribute medical data related to their own health status and care. Furthermore, certain entities (e.g., employers, insurance companies) have become aware that having access to certain aggregated health-related information with respect to groups of individuals in their own organization may provide a number of benefits. However, each of these existing techniques has various problems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment that includes a Wellness Information Analysis (“WIA”) system as well as various computing systems associated with one or more wellness service providers, with one or more member users of the WIA system, with one or more client users of the WIA system, and with various information providers.

FIGS. 2A through 2W illustrate examples of providing a wellness information analysis system via various graphical user interfaces displayed on an exemplary computing system of an individual member user.

FIGS. 3A-3H illustrate examples of a graphical user interface provided by a wellness information analysis system as displayed on an exemplary computing system of a client entity user.

FIG. 4 is a block diagram illustrating a computing system suitable for executing an embodiment of a system that performs at least some techniques described in the present disclosure.

FIG. 5 is a block diagram illustrating an overview of operations according to an embodiment of a WIA system.

FIG. 6 is a block diagram illustrating an alternative overview of operations according to an embodiment of a WIA system.

### BRIEF SUMMARY

A system and methods are provided for integrating and analyzing information related to the wellness of individual users or groups of users including groups such as corporations, companies, governmental or non-governmental organizations, geographical regions, or other groups, all of which are interchangeably referred to herein as entities, entity users, or client entity users. By directly or indirectly providing such wellness information to the system, and/or to a Web site provided by the system, an individual or entity user may receive additional information back from the system, such as explanations and/or recommendations from the system related to wellness of the individual or entity user. In addition, the system may integrate large amounts of data from sources other than the individual user, and perform various analyses to provide additional contextual information to the user regarding his or her wellness, such as providing one or more ratings of the user's wellness. By using the system to know about his or her own wellness, change his or her activities by following system recommendations, and track results of those changes over time, the user may utilize the system to effect a feedback loop for improving his or her wellness. Further, data integrated and/or provided by the system may be used to address the needs of entity users as well as those of individual users associated with them, such as by providing such entity users with various types of information regarding the individual or aggregate wellness of individual users associated with the entity.

Explanations from the system may enable the user to improve his or her understanding of their own current wellness, while recommendations from the system may provide the user with concrete and discrete activities that he or she may undertake to improve the user's wellness over time. For example, a user may provide the system with raw data representing that user's BMI (Body Mass Index). The system may, in response, provide contextual information to improve the user's awareness of how that BMI data affects the user's wellness, either overall or with respect to particular categories or subcategories of wellness. Furthermore, the system may additionally provide recommendations for certain exercises or other activities that may improve the user's wellness with respect to those same categories or subcategories.

As one example, high-level wellness categories might include one category corresponding to “Heart,” another corresponding to “Vitality,” and still another corresponding to “Energy.” Each of those categories may comprise a number of subcategories—the “Heart” category, for instance, may in certain embodiments include subcategories corresponding to “cholesterol,” “blood sugar,” “waist circumference,” and/or other subcategories. As part of receiving various types of wellness information for a particular user, the system may determine one or more categories or subcategories to which particular segments of the received information applied or may be applied, and may consequently initiate or update the storage of additional analytical information with respect to that user for each of the applicable categories and subcategories. In addition, in certain embodiments the system may determine to display explanations, recommendations, or other information to a user in a manner that associates such displayed information with particular categories and/or subcategories.

In addition to functionality provided for individual users, the system may allow an entity that is associated with multiple individual users to provide and obtain information related to the aggregate wellness of those multiple individual users. For example, in certain embodiments, the system may provide various dashboard displays to the client user that indicate contextual information or particular recommendations that may allow the client user to assist its associated individual users in improving their wellness. In at least some embodiments, the WIA system may provide such dashboard displays to a wellness coach associated with a client entity and with one or more individual users, such as to provide the wellness coach with information regarding those associated individual users in order to provide the individual users with supplemental wellness care.

Techniques are described for facilitating the integration, analysis and presentation of various information related to the health of individual users and groups of those users, including in some embodiments and situations to provide such functionality for individual users interested in improving their own health and wellness, as well as for organizations and entities interested in monitoring and possibly improving the aggregate health and wellness of their members and/or employees. Some or all of the techniques described herein may be performed by automated operations of an embodiment of a Wellness Information Analysis (“WIA”) system, such as via a website or other site of the WIA system, as discussed in greater detail below.

In certain embodiments, the described techniques include computer-implemented methods performed by one or more computing systems that are configured to provide a Wellness Information Analysis service. Such methods may include receiving information related to the wellness of a user from one or more of a plurality of data sources associated with the user, and based on the received information, generating a wellness rating for the user. The generating of the wellness rating may be based in part on the received information and based further in part on one or more weighting factors applied to the received information. The methods may further include providing an indication of the generated wellness rating to the user, and in certain embodiments may additionally include providing one or more recommendations for improving the wellness of the user. The computer-implemented methods may additionally include, at a time subsequent to originally providing the indication of the generated wellness rating, receiving additional information related to the wellness of the user from at least one of the plurality of data sources associated with the user, and generating a modified wellness rating for the user based at least in part on the receiving of the additional information.

As another example, in certain embodiments, the described techniques include additional computer-implemented methods performed by one or more computing systems configured to provide a Wellness Information Analysis service. Such additional methods may include, for each of a plurality of users associated with a particular client entity, generating one or more wellness ratings associated with the user (such as generating wellness ratings based in part on receiving information related to the wellness of each user and on one or more weighting factors applied to the received information). Each of the generated wellness ratings for a particular user may indicate a value representing the wellness of the user over one or more of multiple categories associated with the received information for that user. The computer-implemented method may additionally include analyzing the received information related to each of the plurality of users with respect to each of the multiple categories. The analyzing of the received information may include determining a respective priority to assign to each of at least some of the multiple categories with respect to the plurality of users. Based on such analysis, the computer implemented method may further include determining one or more recommendations for facilitating an overall improvement of a health of the plurality of users with respect to one or more of the multiple categories, and displaying an indication of at least one of those determined recommendations to the client entity associated with the plurality of users.

### DETAILED DESCRIPTION

The present disclosure is directed to providing a wellness information analysis Web site, database and/or mobile presence that enables individual users to provide health-related information in various manners in order to obtain insight into the user's own wellness. For example, the user may view one or more ratings related to the user's overall wellness, the user's wellness with respect to individual categories, the user's wellness with respect to other users, or other aspects. In addition, a user may obtain assistance from the site in facilitating various wellness improvements by receiving individualized recommendations for activities and/or lifestyle changes that may improve the individual user's wellness in one or more ways.

After providing an initial set of information to the site, a user may in at least some embodiments provide additional information, such as updated medical information or indications of new activities undertaken by the individual user (e.g., activities resulting from the earlier recommendations provided by the site, or other activities), and receive various information and insights regarding changes in the user's wellness over time. In this manner, a member user may utilize the WIA Web site in a manner that enables a positively-reinforced feedback loop regarding that user's own wellness. For example, a user may provide the initial set of information to the site; receive one or more individualized recommendations from the site based on that initial set of information; and observe the changes to the user's overall wellness as a result of implementing one or more of the individualized recommendations. Such a feedback loop may be further enhanced by tracking various aspects of the user's wellness over time. Furthermore, in certain embodiments the system itself may adjust ratings, recommendations, and/or the manner in which such ratings and recommendations are determined based upon such feedback, as well as other changes and information provided to the system over time.

In addition, “client users” or “client entity users” of the WIA system (e.g., employers, hospitals, physician groups, integrated delivery networks, accountable care organizations or other organizations and such entities' representatives) may in at least some embodiments use the WIA Web site to retrieve information about aggregated aspects of the health and wellness of groups of individual users associated with the client entity, including to provide various search criteria to the site in order to identify particular categories in which such groups may benefit from various wellness improvements, and/or to receive one or more recommendations for such improvements that the client entity may provide or offer to provide for those groups in order to increase overall wellness of the group members.

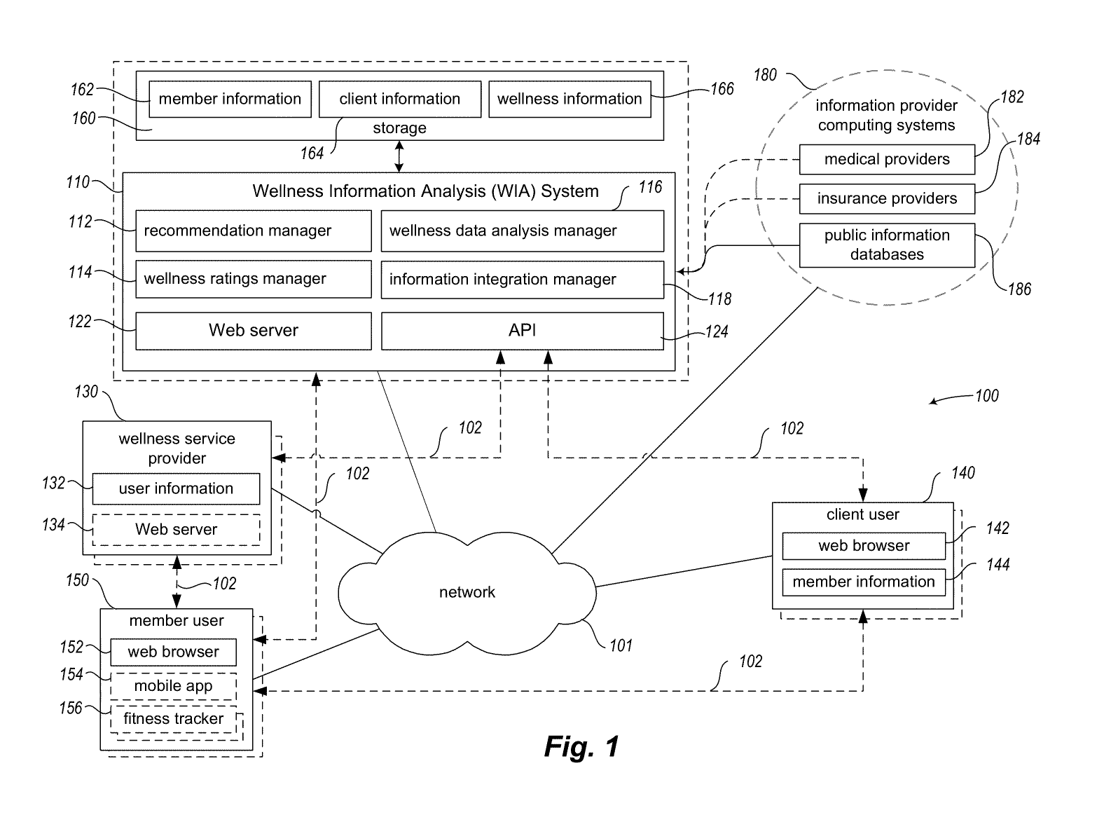

FIG. 1 is a schematic diagram of a networked environment 100 that includes a Wellness Information Analysis (“WIA”) system 110 as well as various computing systems associated with one or more wellness service providers, with one or more member users of the WIA system, with one or more client users of the WIA system, and with various information providers. In at least some embodiments, information that is integrated and analyzed for a particular client user may correspond to multiple distinct individual member users. With respect to at least some embodiments discussed below, the discussion may refer to aggregating types of information associated with member users and client users, but it will be appreciated that the same or similar techniques may be applied to other types of information and for other types of uses in other embodiments.

As described herein, member users of a Wellness Information Analysis (WIA) system may include individual users of that system or any other entity interacting with the system on behalf of an individual user, including past, future or current users of the WIA system. Client entity users of the WIA system may include any individuals or entities interacting with the WIA system on behalf of a group of affiliated people (e.g., a business or other organization) or other entity. Reference herein to “users” without further designation may include a single person, or in some situations a group of affiliated persons, and may, depending on the context in which the term is used, refer to member users, client entity users, or other individuals and/or entities. As one example, a client entity user may operate as a ‘wellness coach’ for each of one or more individual users, such as for purposes of providing follow-up or supplemental care from a client entity, such as a medical provider, employer, or other client entity associated with the individual user.

As used herein, the term “wellness,” with respect to one or more users or information, includes and encompasses all aspects of health, fitness, medicine and medical knowledge (including those collectively and/or traditionally termed “Eastern medicine” and “Western medicine”) and other factors contributing to an overall description and understanding of human well-being. The term “rating,” when used herein, may refer to a score, index, valuation or other singular or collective value that may be analyzed, stored, calculated and/or provided in a numerical or other manner. The term “selecting,” when used herein in relation to one or more elements of a graphical user interface or other electronic display, may include various user actions taken with respect to various input control devices depending on the client computing device used to interact with the display, such as one or more clicks using a mouse or other pointing device, one or more tapping interactions using a touch screen of a client device, etc.

The illustrated example of FIG. 1 includes a number of member users 150 and client users 140 that are each interacting at various times with an embodiment of a Wellness Information Analysis system 110, either via one or more intervening networks 101 or via one or more wellness service providers 130.

The interactions of member users 150, client users 140, and other entities with the WIA system 110 may occur in various ways, such as, in an interactive manner via one or more graphical user interfaces (not shown) that is provided by the WIA system 110 to those users and/or other entities via at least some Web pages of a WIA system Web site provided by Web server 122. The Web site may be provided in a programmatic manner by one or more client software applications via an Application Program Interface (“API”) 124 provided by the WIA system 110 that allows computing systems and/or programs to invoke such functionality programmatically, such as using Web services or other network communication protocols. In the illustrated embodiment, various interactions between a member user 150 and the WIA system 110 and/or a wellness service provider 130 may be performed using any or all of a web browser 152, a mobile application or “app” 154 executing on a mobile device of the user, or one or more fitness tracking devices 156 associated with the user. The web browser 152 may be executing on a fixed or mobile computing device associated with or otherwise available to the member user. The fitness tracking devices may be monitoring various activities or statuses, such as a heart rate of the user, a glucose level of the user, a number of steps taken by the user during a particular time period, a distance traveled by the user, etc. In a similar manner, a client user 140 may in certain situations effectuate various interactions with the WIA system 110 using a web browser 142, such as may be executing on a computing device (not shown) associated with the client user.

The wellness service provider 130 may store various types of information about the member user or interactions associated with the user in a user information database 132, and may facilitate various interactions using a Web server 134. In a similar manner, client user 140 may store various information about member users associated with the client user within member information database 144.

The WIA system may operate as a health intelligence platform to provide efficient collection, aggregation, integration and analysis of information related to an individual user's wellness from multiple sources, and may therefore increase the individual user's knowledge by providing easily understood descriptions of such information and its underlying impact on overall user wellness or aspects. In certain embodiments, sources of wellness information with respect to a member user may include answers to various assessments and queries posited by the WIA system to the user; data provided by one or more mobile devices associated with the user (such as may be collected and provided to the WIA system via one or more applications executing on the mobile device, or in some other manner); the results of one or more medical histories or medical tests related to the user (such as may be provided to the WIA system by a medical or insurance provider authorized by the user to share such results with the WIA system, or directly provided by the user); data provided by one or more wellness service providers, such as may be employed by a member user or client user directly, or via one or more partnership agreements between the wellness service provider and an operator of the WIA system; data provided to the WIA system by one or more fitness-tracking devices, activity-tracking devices, monitoring devices or other devices employed by the user (such as may interact with the WIA system or a wellness service provider via one or more programmatic interfaces, Web services or other interface provided by the WIA system and/or the wellness service provider); or other source of wellness information related to one or more member or client users.

The WIA system may perform automated operations to collect and integrate some or all of the information received and stored related to a particular user for presentation to that user in various manners, such as via a Web site associated with and provided by or communicatively coupled to the WIA system, a mobile application executing on one or more mobile devices associated with the user, etc. For example, a WIA Web site may present one or more views of the user's integrated information to the user using various graphical user interfaces (“GUIs”) or other graphical- or text-based manners, and may present such information as a whole or oriented towards one or more categories.

In various embodiments, such categories may be determined by the WIA system and/or configured in various ways by one or more users or administrators of the WIA system and/or the WIA Web site. In at least some embodiments, the presentation of wellness information to the user may include either or both of “raw data” and various descriptions and explanations of such data, such as may convey additional layers of meaning to the user related to various medical information and databases. The analysis and presentation of wellness information related to one or more users and/or groups of users may be differentiated according to various criteria, such as providing differentiated analysis and the results of such analysis based on circumstances particular to the one or more users and/or group of users. For example, the analysis and presentation of wellness information related to one or more medical conditions may be differentiated based on demographic factors related to such medical conditions and particular demographic factors associated with the one or more users and/or group of users. The system may present risk factors associated with skin cancer and outdoor activities for users located in a geographic region associated with higher temperatures and greater exposure to direct sunlight. The system may access the information about the user's geographic location directly from the user's input or the system may be configured to receive information from the user's mobile device. For example, the mobile device may provide GPS information to the system or the mobile device may be configured to detect external temperature and share that information with the system.

The WIA system may generate and associate with a user one or more wellness ratings. Such wellness ratings may in various embodiments be based on one or more of the following non-exclusive list: wellness information provided by the user; wellness information related to the user that is provided by one or more additional sources associated with the user, as described in greater detail below; information contained in one or more medical or other databases communicatively coupled to, accessed by, or otherwise received by the WIA system (e.g., the Open Government Data Initiative of the United States' Department of Health and Human Services, various databases provided by the World Health Organization, or as may be provided by other governmental or non-governmental agencies and organizations); geographical and/or demographic information provided to or otherwise received by the WIA system; third-party entity reports and/or recommendations; one or more data analytics engines associated with or communicatively coupled to the WIA system; and various other wellness and/or medical information.

In the illustrated embodiment, the WIA system 110 includes a recommendation manager component 112; a wellness ratings manager component 114; a wellness data analysis manager component 116; and an information integration manager component 118. In addition, the WIA system includes the aforementioned Web server 122 and API 124, both of which may facilitate various interactions with any or all of wellness service providers 130, client users 140, and member users 150. The WIA system may be communicatively coupled to one or more storage components 160, which in the illustrated embodiment of FIG. 1 include member user information 162, client user information 164, and wellness information 166. In certain embodiments, storage components 160 may be operated by a third-party data storage service provider, such as may provide various cloud-based storage services; in other embodiments, storage components 160 may be integrated into the WIA system directly, and may be operated by a WIA service provider that operates the WIA system.

In situations in which the WIA system 110 or a wellness service provider 130 provide one or more Web sites respectively provided by Web servers 122 and 134, at least some member users 150 and/or client users 140 may perform at least some interactions at such Web sites. For example, a member user may use a client computing device (not shown) to interact with the WIA system 110 over networks 101, such as to obtain Web pages or other electronic information pages (e.g., HTML-based emails, or other groups of information that are formatted at least in part based on HTML or other formats or markups) from the WIA system, and to optionally provide various wellness information. Such member users 150 may access a Web site provided by the WIA system to obtain one or more Web pages, such as to view information about, search for, browse for, and/or provide information related to the wellness of the member user, and in certain embodiments other member information (e.g., member account information, preference information, etc.) stored by the WIA system 110. In certain embodiments, the WIA system may store various types of member information 162 about such online interactions, including in some cases to record and store information about all interactions and activities performed by the member user with respect to the WIA system.

In this example, the network 101 is a publicly accessible network of linked networks, possibly operated by various distinct parties, such as the Internet, although in other embodiments the network 101 may have other forms. For example, the network 101 may instead be a private network, such as, a corporate or university network that is wholly or partially inaccessible to non-privileged users. In still other embodiments, the network 101 may include both private and public networks, with one or more of the private networks having access to and/or from one or more of the public networks. Furthermore, the network 101 may include various types of wired and/or wireless networks in various situations. In addition, in this illustrated example of FIG. 1, the member users 150 and client users 140 may use client computing systems and/or other client devices (not shown) to interact with the WIA system 110 to obtain various described functionality via the network 101, and in doing so may provide various types of information to the WIA system 110. Moreover, in certain embodiments, the various users and providers of the networked environment 100 may interact with the WIA system and/or one or more other users and providers using an optional private or dedicated connection, such as one of dedicated connections 102. For example, dedicated connections 102 may include one or more VPN (Virtual Private Network) connections.

The WIA system may in certain embodiments receive various types of information from additional information provider computing systems 180, such as those that may be operated by medical providers 182, insurance providers 184 and public information databases 186. Under certain situations and scenarios, the WIA system 110 may optionally obtain authorization from a member user 150 to receive information related to the member user (e.g., electronic medical records, medical history information, various test results, etc.) directly from a medical provider or insurance provider associated with the member user, and may thereby integrate such information into WIA system records for the member user without requiring additional interaction from the member user. In addition, the WIA system may obtain and integrate various types of information from public information databases 186, such as geographic and demographic information, reports from governmental or non-governmental organizations or entities, or other information that may be relevant to member and/or client users of the WIA system. For example, the WIA system may obtain various information from the Open Government Data Initiative (“OGDI”) based in the United States, a cloud-based open software initiative that enables publicly-available government data (such as data available from the Department of Health and Human Services) to be accessed using various programmatic or other interfaces. Such information may be analyzed in various manners by the WIA system, such as by the wellness data analysis manager component 116 and/or the information integration manager component 118 of FIG. 1.

In certain embodiments and situations, one or more wellness ratings may be determined for a user relative to other users of the WIA system or various subsets of the greater population, such as to determine a wellness rating for a particular wellness category by comparing information associated with a particular user with wellness information relevant to that greater population (e.g., a subset of WIA system users or greater population that is demographically similar to the user for which the wellness rating is generated). In other situations, wellness ratings may be provided that are relative to a scale independent of any users or population other than the specific user for which the rating is generated. In addition, in certain embodiments one or more wellness ratings may be determined for entity users or other groups of individuals in order to provide analysis and/or recommendations related to the wellness of such entities or other groups, either as a whole or with respect to particular wellness categories or subcategories. As one non-limiting example, one or more ratings may be determined for an entity user by determining one or more sums of corresponding ratings that have been previously determined for constituent individuals associated with the entity user. In various embodiments, other methods of determining aggregated ratings applicable to entities or other population groups (e.g., demographic and statistical analysis, etc.) may be utilized based on one or more wellness ratings determined for individuals associated with such entities or groups, and/or based on wellness ratings associated with constituent groups associated with an entity.

The generating of the wellness ratings associated with a particular individual user or client entity user may, in certain embodiments, include analyzing various integrated information related to the user based on applying one or more weighting factors to such information, as well as to other information aggregated and integrated by the WIA system. In certain embodiments, for example, information stored about a particular user may include information related to that user's sleeping habits, eating habits, fitness activities, family history, substance use (e.g., alcohol or nicotine consumption, or the use of other recreational and/or pharmaceutical substances). The generating of wellness ratings for such a user may include applying weighting factors to such information in order to provide more accurate wellness ratings for the user—such as may indicate that the user's consumption of cigarettes or other nicotine products may have a greater impact on the user's wellness than various sleeping habits of the user. In certain embodiments, such weighting factors may be statically applied to wellness information with respect to all users in a similar manner; in other embodiments, weighting factors may be dynamically applied to users' information, such as based on demographic information related to the user (such as applying a first set of weighting factors with respect to male users, a distinct second set of weighting factors with respect to female users, additional weighting factors with respect to those users over or under a predetermined age, etc.), one or more medical conditions of the user (such as to apply particular weighting factors with respect to those users identified as having diabetes, various genetic conditions, etc.), one or more genetic or other predispositions of the user (such as to apply various particular weighting factors based on the results of one or more medical tests, such as blood or DNA analysis), or other information specific to a particular user. Furthermore, in certain embodiments, weighting factors used for the generation of one or more wellness scores specific to a particular user may change over time, such as based on one or more changes of information related to the wellness of the user, on the age of the user, on updated general medical information or specific medical knowledge independent of activities of the user, etc.

In at least some embodiments, the WIA system may determine various categories and/or subcategories with which to associate various aspects of information related to one or more users and/or groups of users. Such categories may be based, for example, on factors similar to those described above with respect to the determination of one or more weighting factors for use in generating wellness ratings associated with users of the WIA system, and may include recommendations or other information provided by medical professionals; medical professional organizations; or other sources of information. In certain embodiments, the WIA system may present information to one or more users based on such determined categories and/or subcategories. Furthermore, the WIA system may use distinct sets of such categories and/or subcategories in various ways. For example, the WIA system may utilize one set of categories and/or subcategories for purposes of analysis, integration and storage of various wellness information within the WIA system, and a distinct other set of categories and/or subcategories for purposes of presentation to users. Moreover, various sets of categories and/or subcategories may be dynamically utilized with respect to the analysis and/or presentation of information related to particular users or groups of users, such that distinct sets of categories and/or subcategories of wellness information are presented to distinct users under various circumstances.

The WIA system may additionally provide various recommendations from the recommendation manager 112 to member users related to one or more aspects, categories, and/or subcategories of information provided to the WIA system regarding the users' individual wellness. In at least some embodiments, such recommendations may be based on the information analysis and integration provided by the WIA system related to generating one or more wellness ratings for a user, such as to generate and provide recommendations of activities that the user may undertake in order to improve an aspect of the user's wellness in which a wellness rating is indicated that is deficient in comparison to other aspects of the user's wellness. In at least such embodiments, the WIA system may determine one or more priorities or prioritization factors associated with various wellness categories and/or subcategories, and may provide one or more recommendations based on such priorities or prioritization factors.

Additionally, activity recommendations and other recommendations may be based on one or more preferences or priorities indicated by the user, and may in certain circumstances be provided even when not otherwise prioritized for that particular user. For example, the WIA system may recommend various fitness activities associated with weight loss or metabolic adjustment for users who have indicated a desire to lose weight, even if one or more wellness ratings of the user do not otherwise indicate that such activities should be prioritized over other recommendations associated with other wellness categories. In various embodiments and circumstances, a variety of recommendations may be provided to users with respect to a single category and/or wellness rating, such as to enable the user to select a subset of such recommendations based on that user's personal preference. Furthermore, in at least some embodiments the WIA system may recommend that the user undertake multiple activities, either sequentially or in conjunction with one another, such as to encourage the user to remain active without becoming bored or otherwise uninterested in completing such activities. In certain embodiments, recommendations of the WIA system may be provided to both the member user and a wellness coach assigned to the member user, such that the system may facilitate the sharing of the member user's progress with respect to such recommendations between the member user and the user's wellness coach.

A user may further be enabled to provide the WIA system with an indication of an intention to complete one or more activities, such as activities recommended by the WIA system or other activities, and the WIA system may track such activity completion in various manners, such as by receiving, from the user or from one or more devices and/or services associated with the user, one or more indications that such activities are in progress or have been completed. Alternatively, the user may complete an activity, such as walking, jogging, hiking, or other type of activity that is trackable by a mobile device, a pedometer, or other device. For example, there are currently devices configured to detect distance traveled by a user, such as a GPS watch or detect a number of steps taken by a user. The WIA system is configured to communicate and receive input from such devices, either by direct input by the user or by other automatic transmission techniques.

In certain embodiments, the WIA system may enable various reminders and other communications related to recommended activities to be sent to the user under various circumstances, such as may be defined by the user configuring various preferences associated with their WIA system account. For example, a user may indicate that scheduled or other reminders be sent to the user at regular intervals, within a predetermined amount of time preceding the user's intended completion of an activity, or at other times. In addition, the user may in certain embodiments specify particular manners of communication that the WIA system should utilize for such communications (such as to allow or disallow communications via text messaging or phone calls associated with one or more specified telephone numbers or other electronic addresses associated with the user, electronic mail messaging at one or more specified email addresses, electronic messages using one or more social networking sites associated with the user, setting a user's mobile device to alarm, etc.).

The WIA system may also enable member users to enter various search criteria related to categories and/or subcategories of wellness information, particular activities associated with one or more aspects of the user's wellness ratings and associated reports, or other criteria. For example, in certain embodiments, the WIA system may enable outcome-based search (e.g., “what can I do to improve my sleep?”); input-based search (e.g., “what happens if I walk more?”, or “what suggested activities involve walking?”); or term-based search (e.g., “walking” or “cholesterol”). Such search functionality may be provided based on a user interface currently displayed for the user, or provided independently of any current display.

The WIA system, in at least some embodiments, may enable users of the system to purchase or otherwise acquire various products and services from the WIA Web site and/or one or more partners of the entity operating the WIA system, such as to facilitate receiving additional wellness information from or related to the users. For example, the WIA system may provide hyperlinks or other communications directing the user to offers for medical tests intended to supplement existing wellness information associated with the user on the WIA system, such as blood tests, DNA tests, etc. As another example, the WIA system may provide the user with offers or opportunities to purchase one or more fitness tracking devices to be integrated with the WIA system in collecting, integrating and analyzing wellness information of the user. In at least some embodiments, the advertising of such offers may be provided based on a variety of particular factors, such as information associated with the particular user, information associated with a client entity associated with the user, demographic information associated with a particular user and selected by the WIA system and/or the advertiser, etc.

In at least some embodiments, the WIA system may provide one or more rewards for completing activities recommended to the user by the WIA system or other activities tracked by or associated with the WIA system. For example, the WIA system may allocate one or more types of “reward points” to a user for completing each activity recommended to that particular user, and may in addition allocate reward points to the user for completing various interactions with the WIA system itself, such as by submitting various wellness information related to the user. Such system rewards may be allocated based on, among other activities: logging into the WIA system and/or WIA Web site; updating information related to the user that is stored by the WIA system; completing a recommended activity; scheduling and/or receiving a reminder related to a recommended activity; sharing on one or more social media sites an intention to complete a particular activity, and/or that a particular activity has been completed; completing one or more user assessments on the WIA Web site; associating a mobile device, tracking device, or other device with the user's account on the WIA system; performing particular user interactions with a wellness coach associated with the user; associating one or more third-party wellness sites with the user's account of the WIA system; ordering or completing one or more medical tests and/or reports; or other activities and interactions. In various embodiments, system reward points that have been allocated to a user may be redeemed for various products, services, discounts on such products and services, or other benefits, such as monetary deposits into a Health Savings Account (HSA) of the user.

The WIA system may in some embodiments provide additional functionality for client users of the WIA system, such as employers or other organizations associated with a particular group of member users of the WIA system. For example, a client user associated with a group of users may be able to view certain aggregated information related to the associated group of users and receive recommendations related to activities that may improve the overall wellness of the associated group. In various embodiments, various privacy protections may be implemented to ensure that the WIA system provides relevant aggregated information to a client entity associated with a group of users, while maintaining the privacy of each member user in that group. Such privacy protections may be implemented in accordance with various regulatory requirements, such as governmental regulatory requirements (e.g., the Health Insurance Portability and Accountability Act of 1996, or “HIPAA”) or regulatory requirements associated with internal or external policies related to the client entity.

While certain individual users may achieve improvements in wellness over time using the WIA system and its recommendations and feedback alone, other individuals may achieve more significant improvement based on interactions with a wellness coach assigned to provide that individual user with supplemental or follow-up care. Typical examples of wellness professionals serving as a wellness coach include physicians, nurses, medical assistants, physician's assistants, or medical educators specializing in one or more medical conditions associated with the individual user to which they are assigned as a wellness coach (e.g., diabetes or other chronic condition). In at least some embodiments, the WIA system may provide particular functionality to support a client entity user tasked with supporting one or more individual users of the system as a wellness coach. For example, the system may provide information to the wellness coach regarding the wellness of her assigned individual users. Such information may include, as non-limiting examples: identification information; demographic information; biometric information; wellness goals (such as personal goals entered by the individual user, goals determined by a physician or other wellness professional associated with the individual user, or recommendations determined by the WIA system), and progress with respect to such goals; progress over time with respect to particular wellness categories and/or subcategories; medical records and history; session history information with respect to the current wellness coach or other medical professionals associated with the individual user; etc. In addition, in certain embodiments the WIA system may facilitate various communications between the wellness coach and their assigned individual users, such as by enabling the transmission of private electronic messages, scheduling in-person visits, providing a point of contact for telephonic or audiovisual conferencing between the wellness coach and individual user, etc. In certain embodiments, the WIA system may provide various custom analytics associated with particular groups of users that are associated with particular client entities. For example, the WIA system may determine one or more priorities or prioritization factors associated with categories and/or subcategories of wellness information stored in relation to the group of member users associated with the client entity, such as to determine particular wellness categories and/or subcategories in which a majority of users associated with the client entity may benefit from additional activities. Additionally, the WIA system may provide contextual information and targeted recommendations to the client entity independent of the information and recommendations provided to individual member users associated with that client entity. As one example, if a majority or other high percentage of a client entity's member users are indicated as having undesirable levels of stress (either related to or unrelated to the users' collective association with the client entity), the WIA system may recommend one or more activities (e.g., providing discounted or free massage therapy to its employees at regular or semi-regular intervals) that may improve the overall stress level of the client entity's associated users. As another example, the WIA system may provide information to the client entity related to particular business risks associated with aggregate data from its associated member users.

The functionality provided by the WIA system for at least some client entity users, based at least in part on the wellness information obtained and stored with respect to its associated member users, may include a variety of types in various embodiments. For example, the types of functionality provided to an authorized user for a particular client entity may in some situations include some or all of the following (and optionally with different authorized users of the client entity having access to different subsets of provided functionality based on roles or other defined access privileges of those authorized users): providing functionality to enable the authorized user to obtain generated analytics information corresponding to various types of member user wellness information and interactions, such as for pre-generated analytics information or instead for analytics information that is dynamically generated in response to a specification of the desired information or other request from the authorized user; providing functionality to enable the authorized user to create member user segments that include a subset of the member users having defined attributes or otherwise meeting specified segment-related criteria; providing functionality to enable the authorized user to specify roles or other defined access privileges for other authorized users of the retailer; providing functionality for an API that enables access to at least some stored data and/or other types of provided functionality from the WIA system; etc. In at least some embodiments, the system may provide recommendations to a client entity user regarding particular segments of individual users associated with the client entity that may benefit from a wellness coach. For example, the system may determine that assigning a wellness coach may result in significant wellness improvements for individual users with particular medical conditions, individual users that have demonstrated progress with respect to one or more wellness categories below a particular threshold, or other criteria. As one example, the WIA system may recommend assigning a wellness coach specializing in diabetes care to individual users diagnosed as pre-diabetic that have a BMI exceeding a defined threshold.

In addition, the system may provide various analytical information and track key performance indicators with respect to the performance of wellness coaches themselves, such as to view engagement levels and aggregate wellness improvements for groups of individual users assigned to particular wellness coaches associated with a client entity. Such key performance indicators may include, as non-limiting examples: a number of interactions with the wellness coach, improvement with respect to one or more wellness categories over the course of such interactions, a percentage of individual users that accomplish a particular wellness goal or level of interaction, etc. In this manner, a client entity user may be able to view the relative effectiveness of particular wellness coaches assigned to individual users associated with the client entity.

In certain embodiments, various search and reporting functionality may be provided, such as to allow the client entity to view various aggregated characteristics of its associated member users. This and other functionality may be limited by the WIA system in order to preserve and protect the privacy of individual member users associated with the client entity. In other instances, the data is presented without identifying criteria such as name, age, race, etc. The WIA system may allow a client entity to search for various information related to predefined or dynamically defined subsets of its associated member users (e.g., to identify a percentage of male users associated with the client entity that are also associated with a vitamin D deficiency, or other desired subsets). However, if the client entity is associated with only a small number of male users, such search functionality may be restricted or eliminated so that information related to individual male users may not be inappropriately exposed. These and other restrictions may be dynamically determined by the WIA system based on a type of client entity (e.g., medical provider, insurance provider, employer, etc.), on information associated with the client entity and its member users, on various criteria provided by administrators of the WIA system, or on other appropriate criteria.

The WIA system may provide additional functionality for particular client entity users. For example, in at least some embodiments, such functionality may include account management functions (to support interactions of a client entity user related to account, billing, preferences, application settings, privacy and security preferences, etc.); membership administration (to allow a client entity user to manage member accounts using one or more interfaces of the WIA system or WIA Web site); and program analysis and reporting functions, such as providing one or more graphical representations of wellness, activities, and behavior related to member users associated with the client entity.

In addition, the WIA system may provide incentive administration functionality, in order to allow a client entity to create and/or configure incentive and/or reward programs. In certain embodiments, client entity users may utilize the WIA system to initiate and manage individual and group pursuits or challenges. For example, configuring a particular incentive program might include selecting a start date for the particular incentive program and choosing one or more particular wellness metrics to track over a particular period of time. Another incentive program might include establishing one or more rewards for individual members associated with the client entity that complete particular assessments, and/or that provide particular information to the WIA system. Still another incentive program might involve tracking one or more metrics as part of a competition for multiple member users (such as by using multiple member users' mobile devices or fitness tracking devices), with particular rewards offered to one or more “winners” of the competition. Various aspects of incentive programs may be configured by the client entity user, such as incentive rewards and communications related to progress or completion of the program.

The WIA system may in some embodiments aggregate information about various types of actions by some or all users of the system and use such aggregated information in various manners, or more generally may generate analytics information (e.g., corresponding to one or more of member users and client users, such as based on information about such users, wellness coaches assigned to such users, particular recommendations and/or sets of recommendations provided to groups of member users by the WIA system and relative efficacy of such recommendations, groups of users and/or various actions of such users, including actions performed with respect to the WIA system or actions taken by such users independent of the WIA system). This information may be provided to particular users of the WIA system and/or entities external to the WIA system under various circumstances. Furthermore, any or all of the various types of actions performed by the WIA system may in some embodiments be performed in exchange for fees charged to corresponding users of the system and/or entities external to the WIA system.

For illustrative purposes, embodiments are described in which various types of information are provided to different types of recipients in various manners, including for different types of informational and other interactions. These examples are provided for illustrative purposes and are simplified for the sake of brevity, and the inventive techniques may be used in a wide variety of other situations, some of which are discussed below.

It will be appreciated that various of the details illustrated with respect to FIG. 1 are provided for illustrative purposes, and may be different in other embodiments. For example, the WIA system 110 may obtain and store other types of information (whether by storing additional types of information, and/or by not storing at least some of the illustrated types of information), and the information may be stored in various manners (e.g., in a multi-tenant data warehouse or other database, in multiple distinct databases that are each specific to a type of data and/or to a particular retailer, etc.), including to be grouped in other manners than is illustrated. Similarly, the WIA system 110 may provide other types of functionality than those described (whether by providing additional types of functionality, and/or by not providing at least some of the described types of functionality), and the functionality may be provided via various types of interfaces.

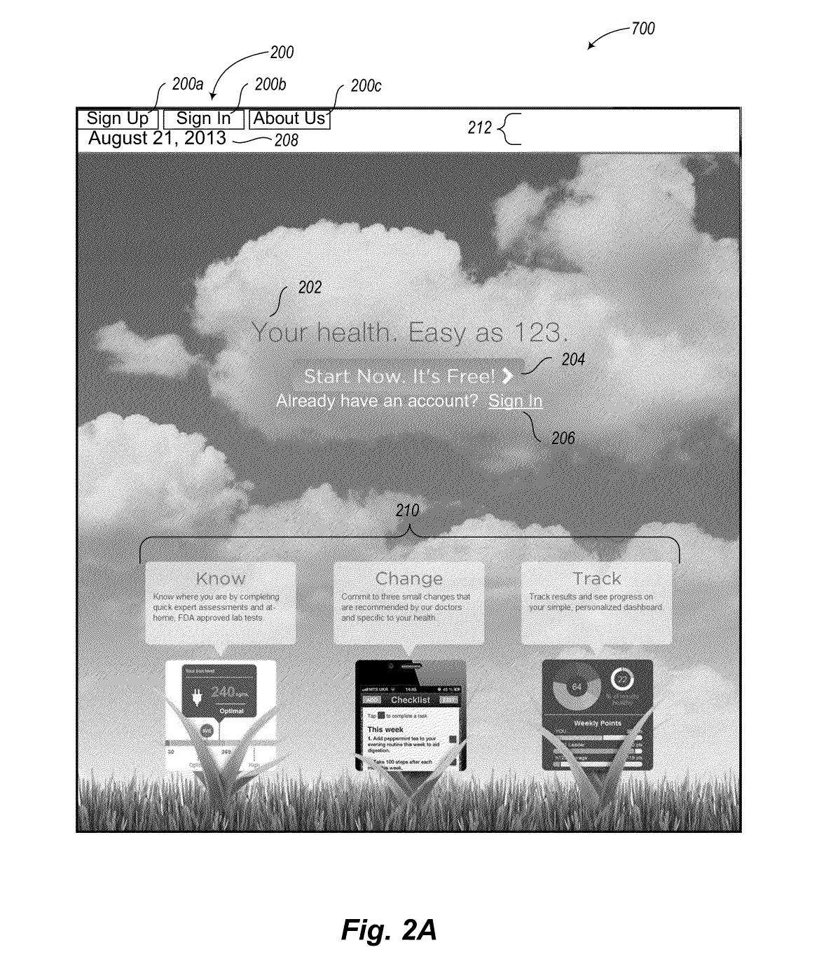

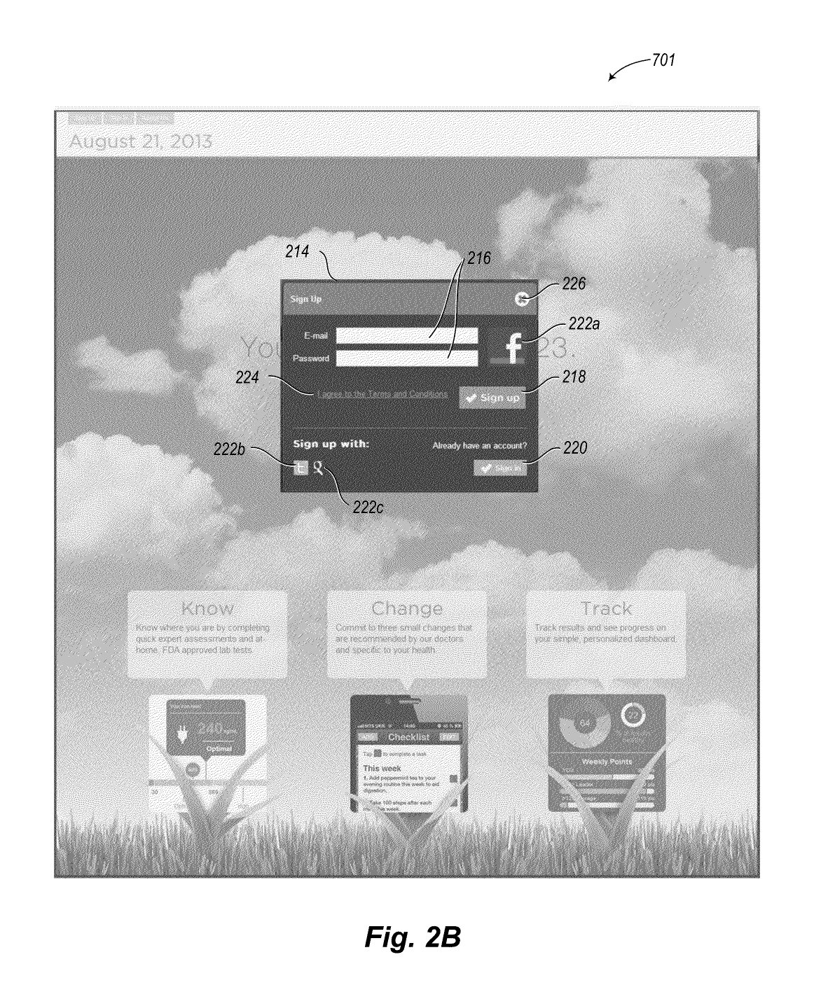

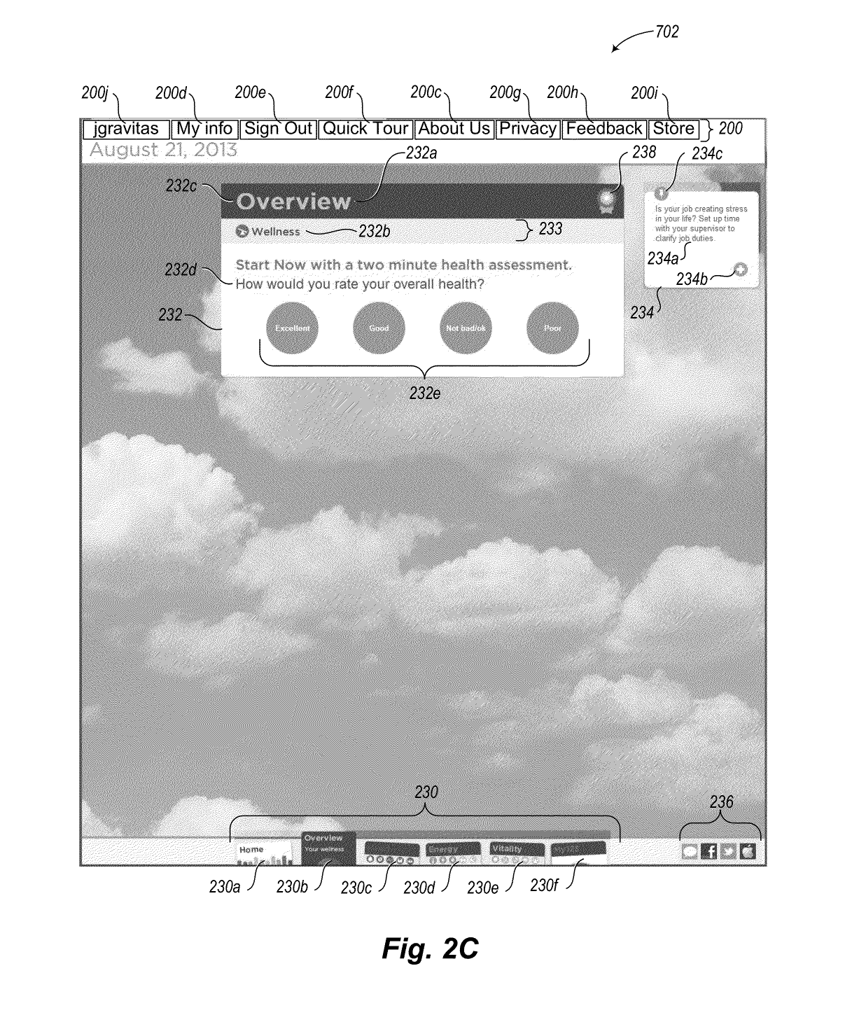

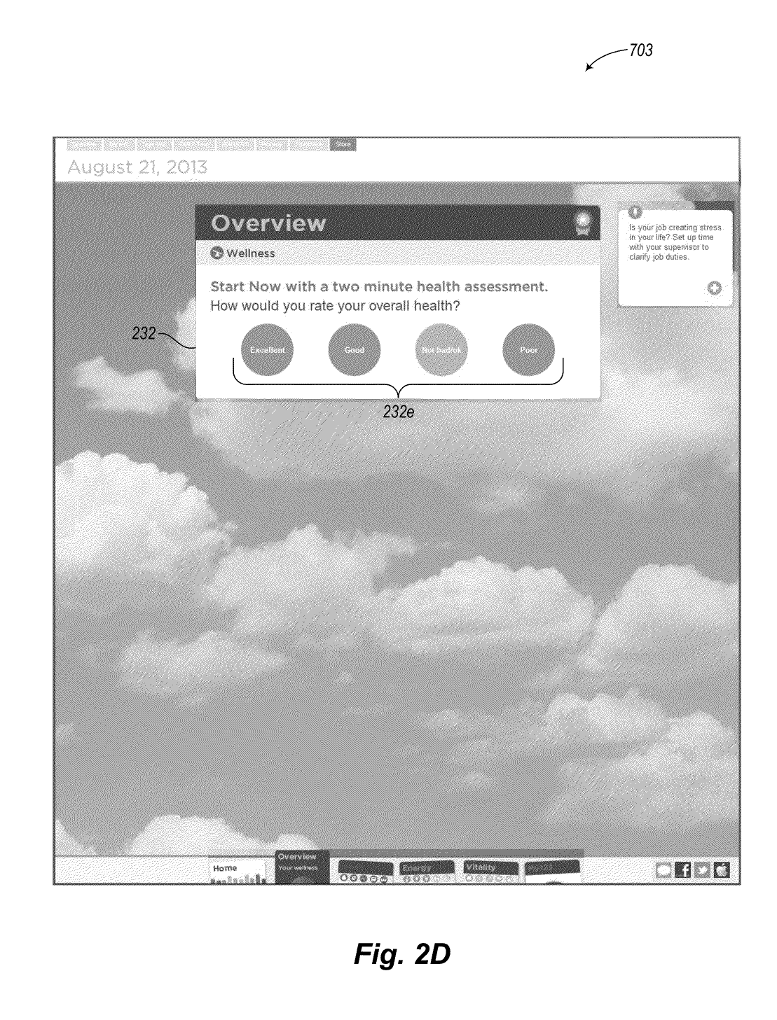

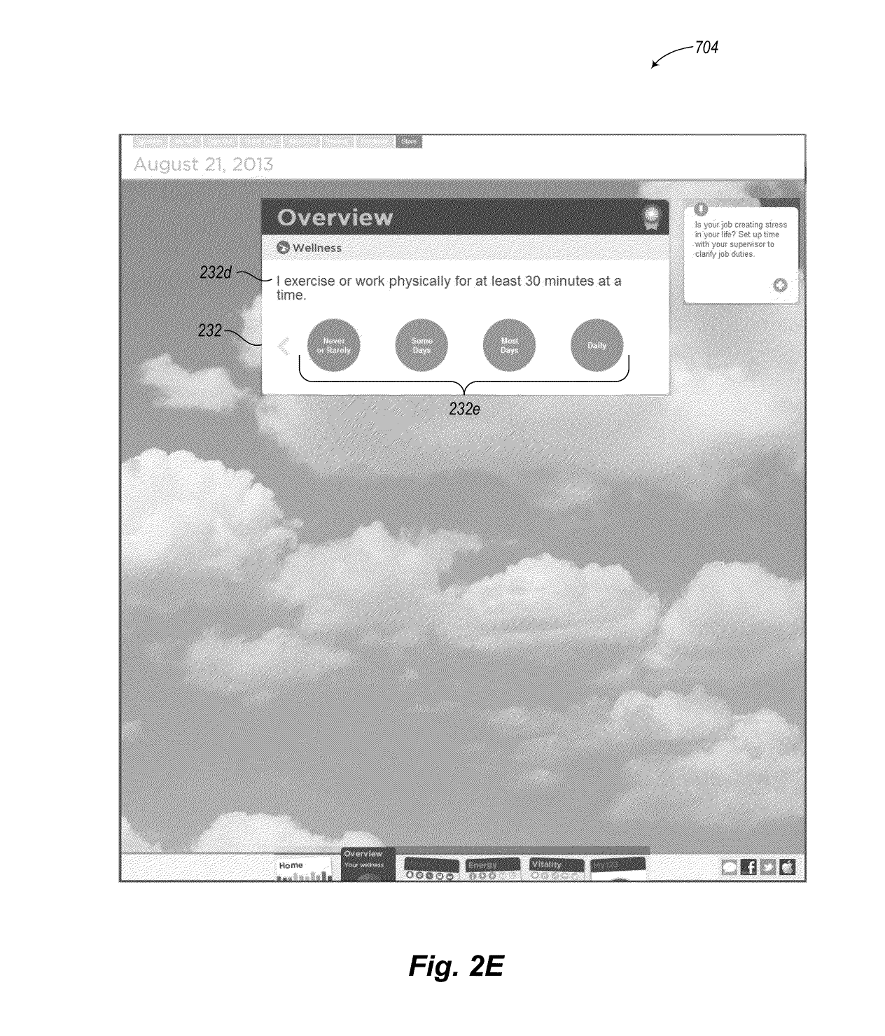

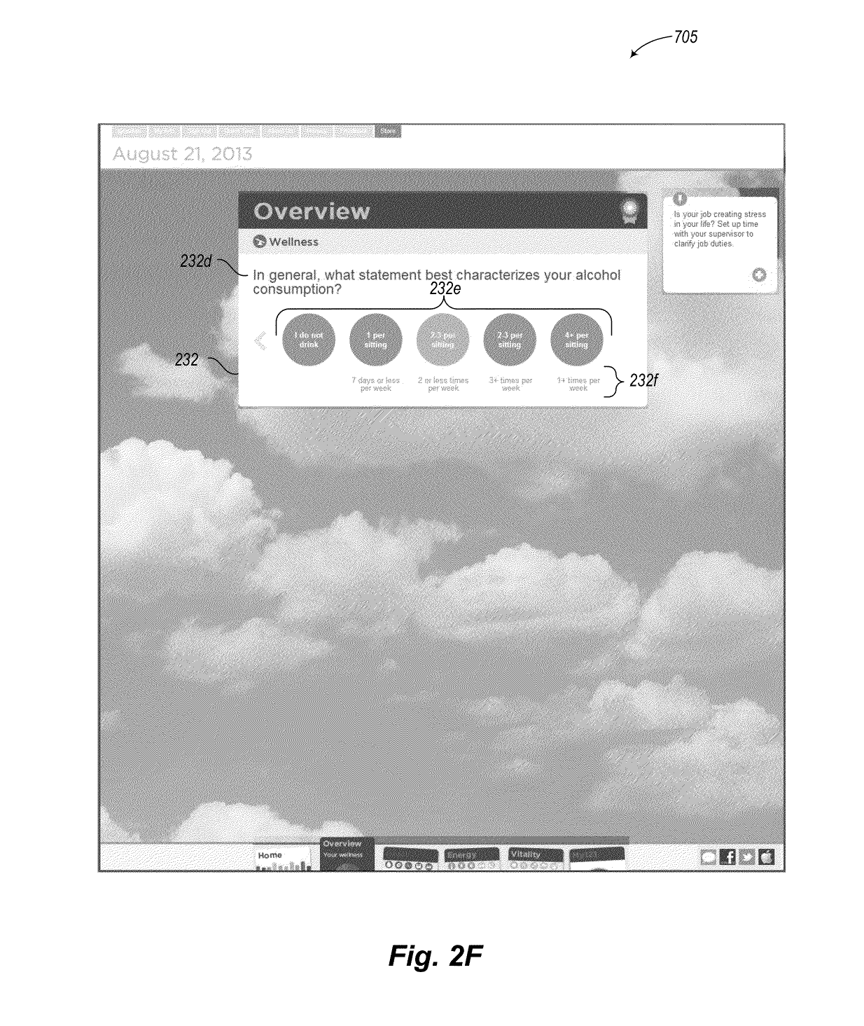

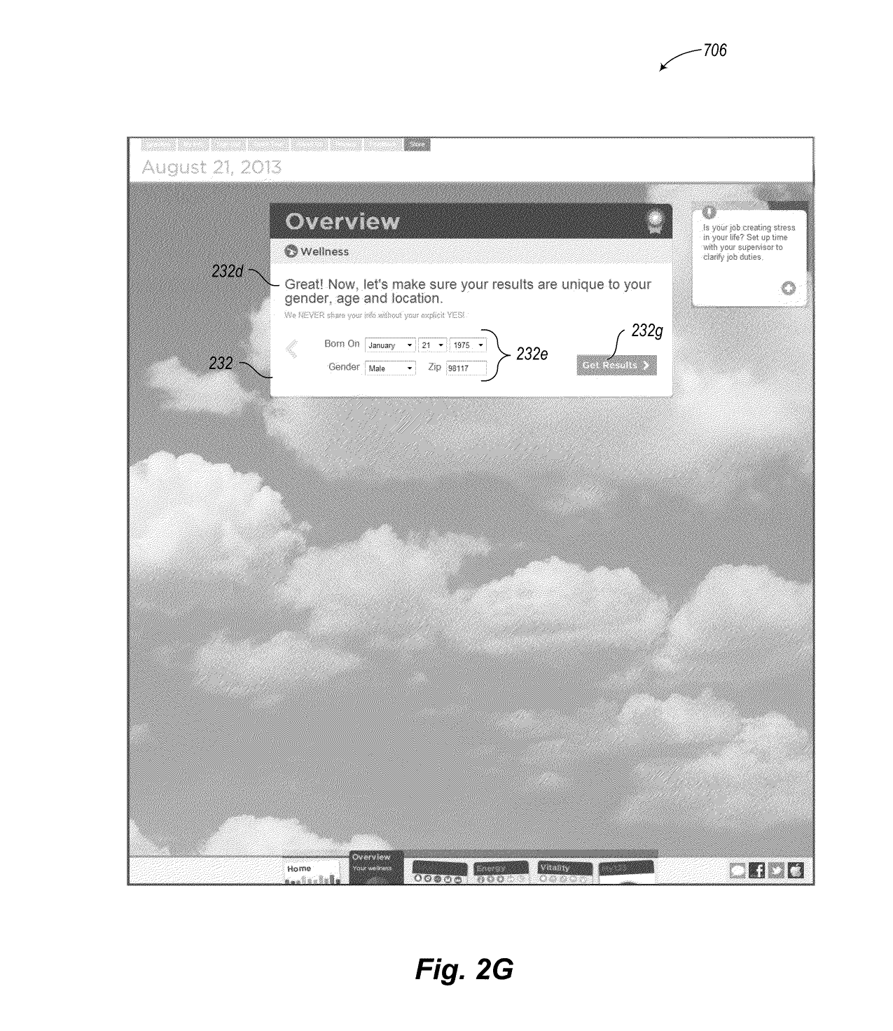

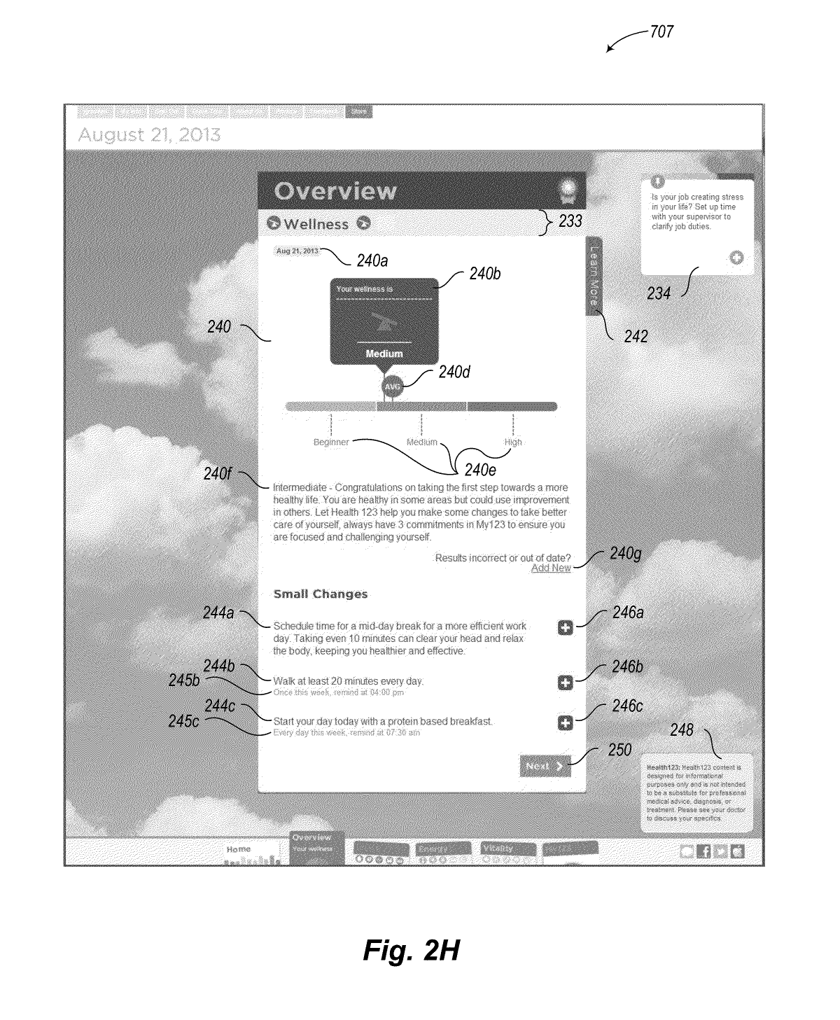

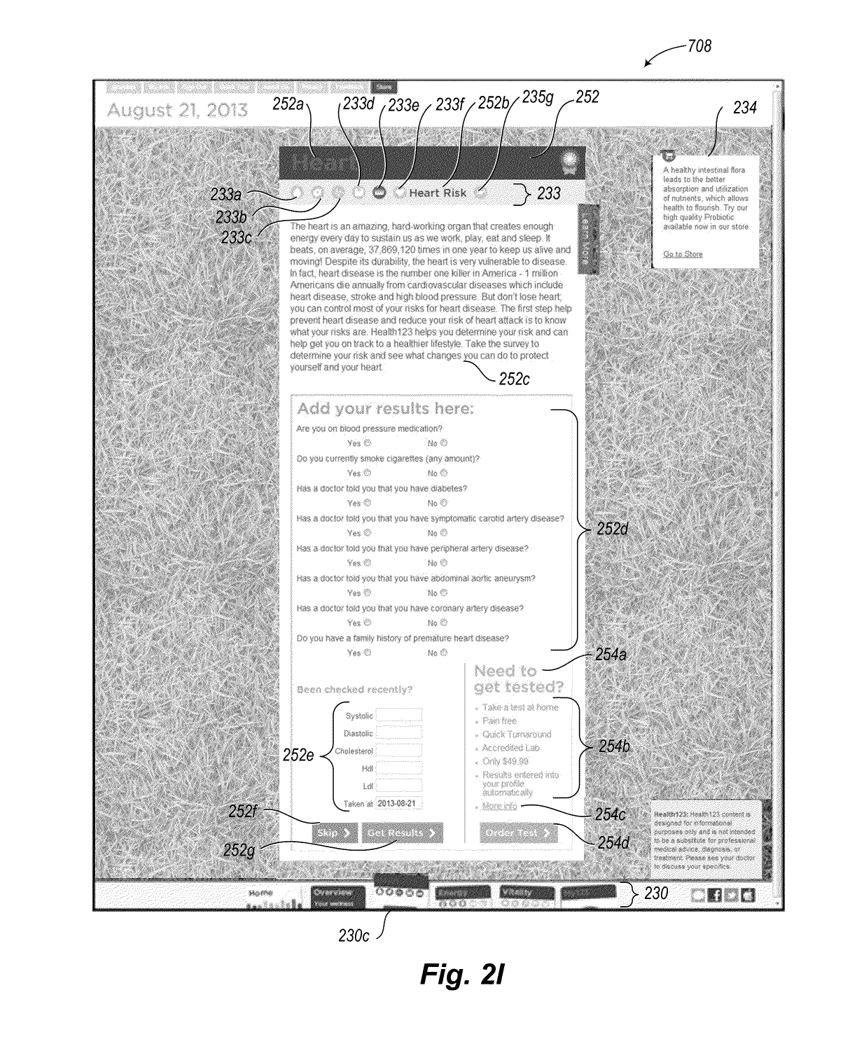

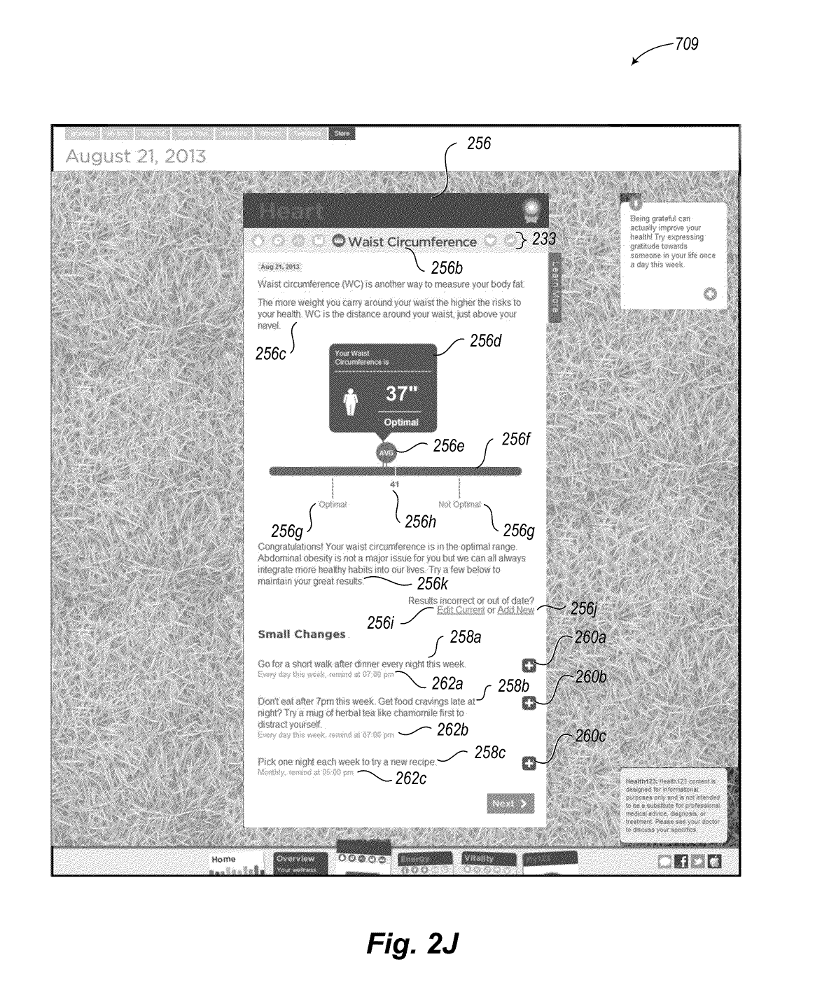

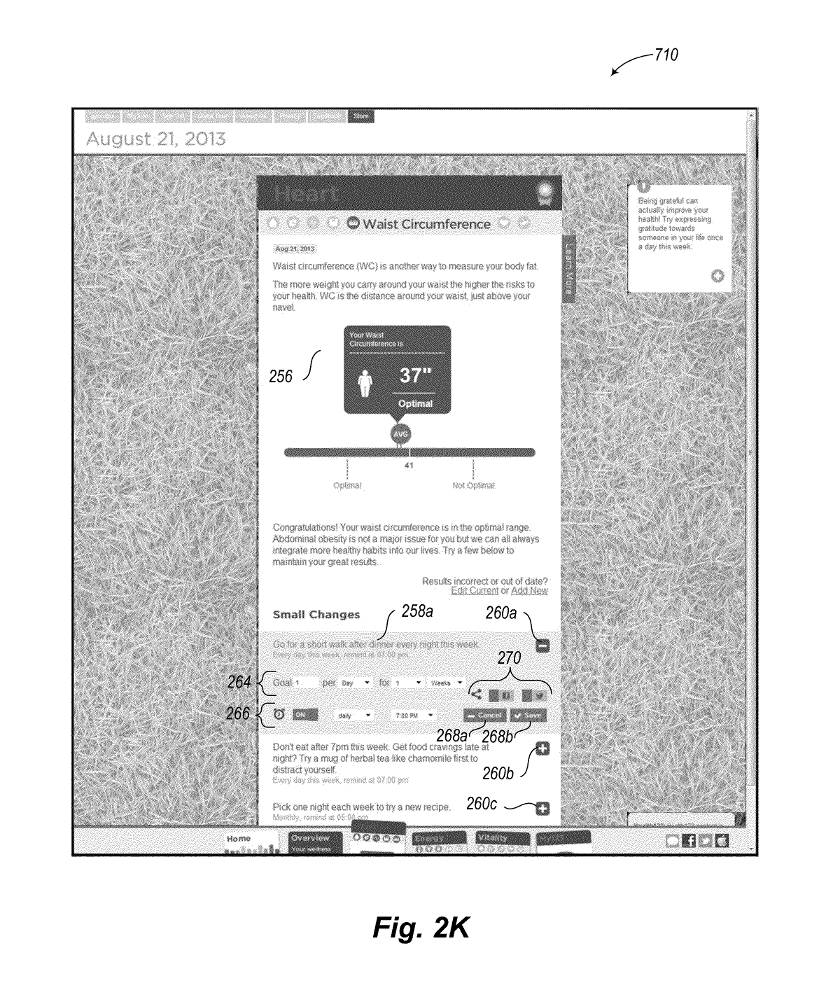

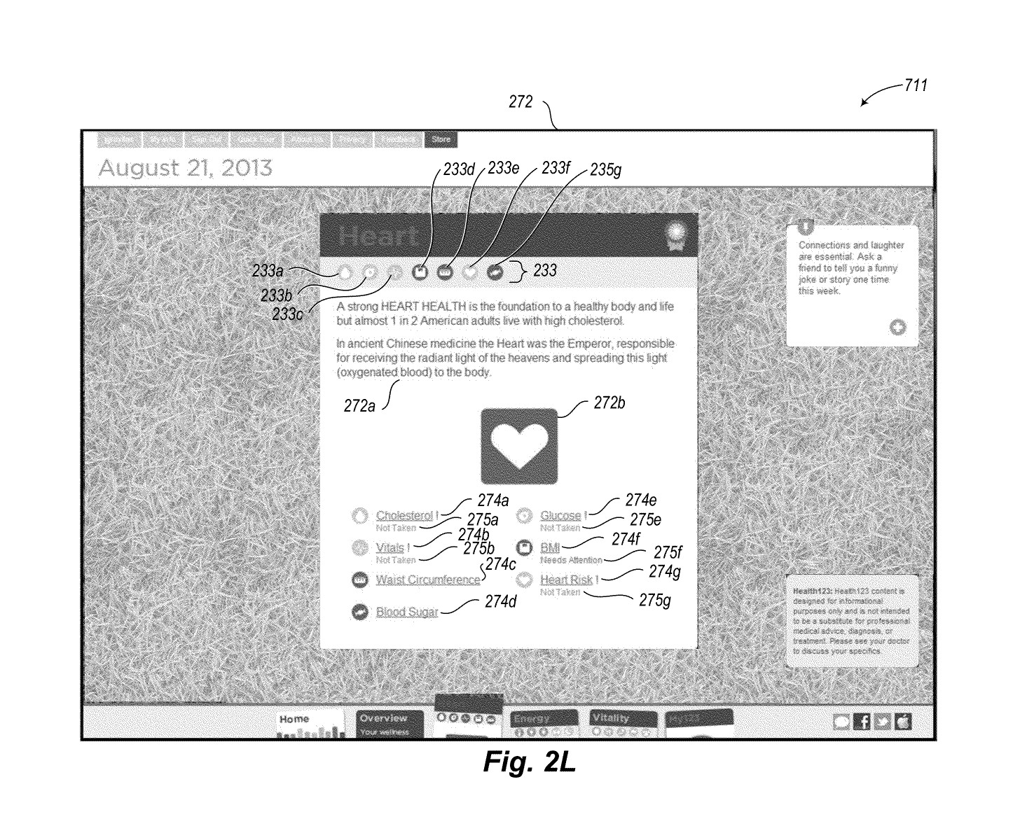

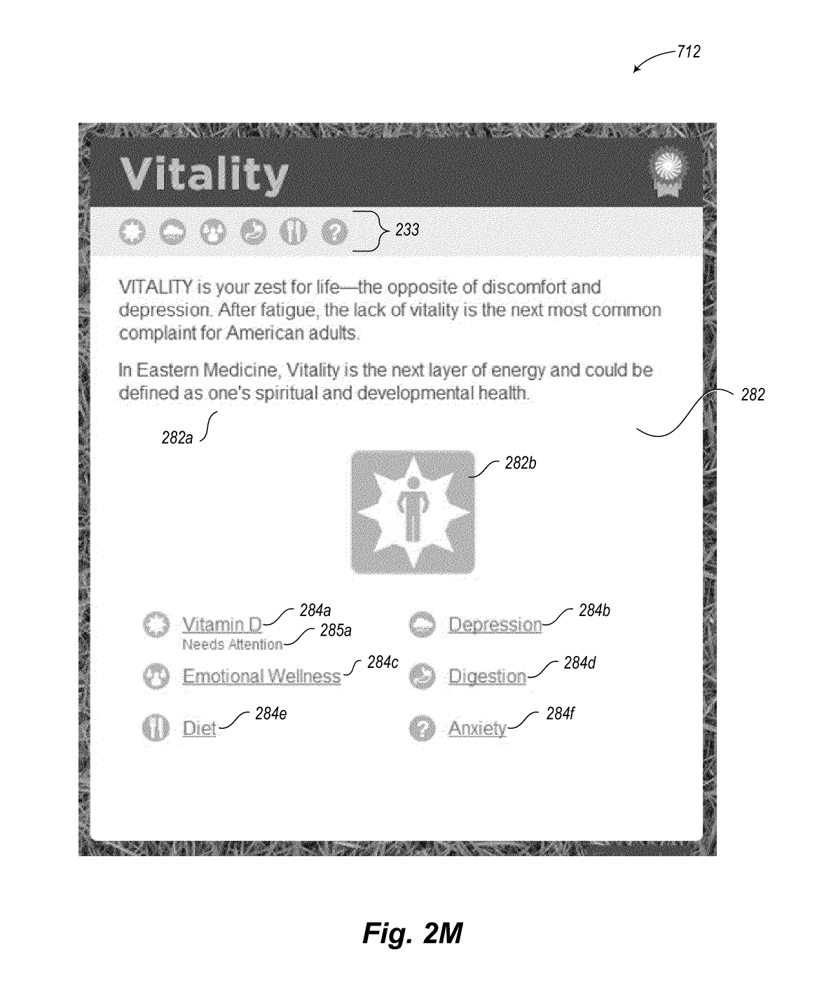

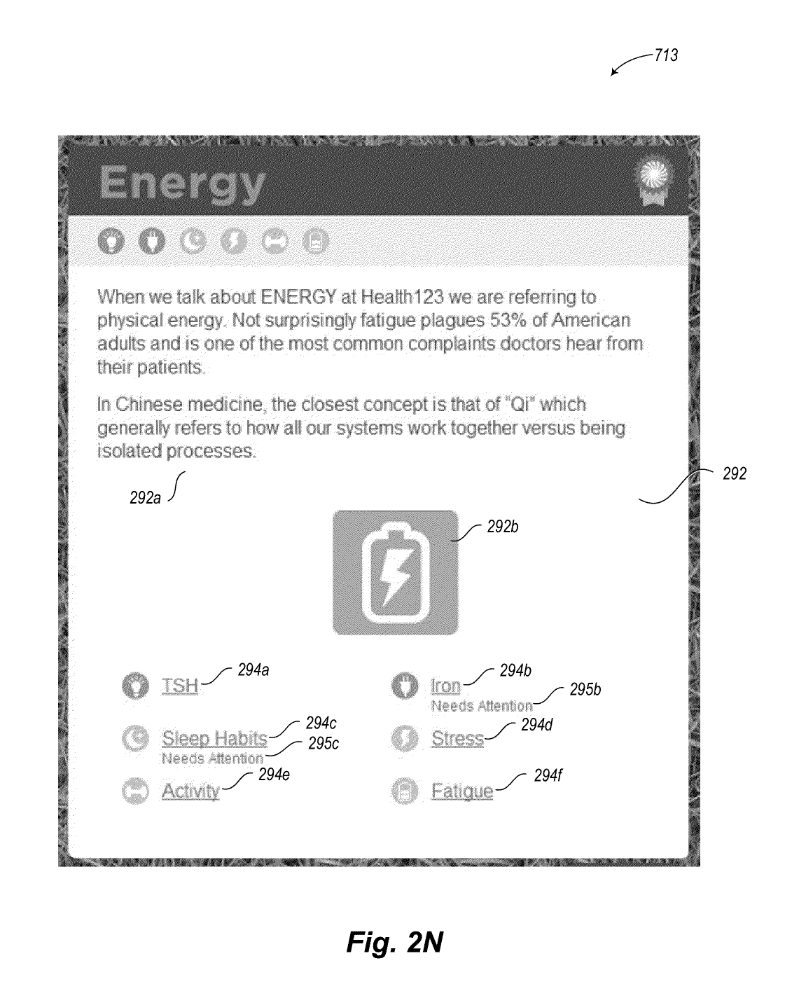

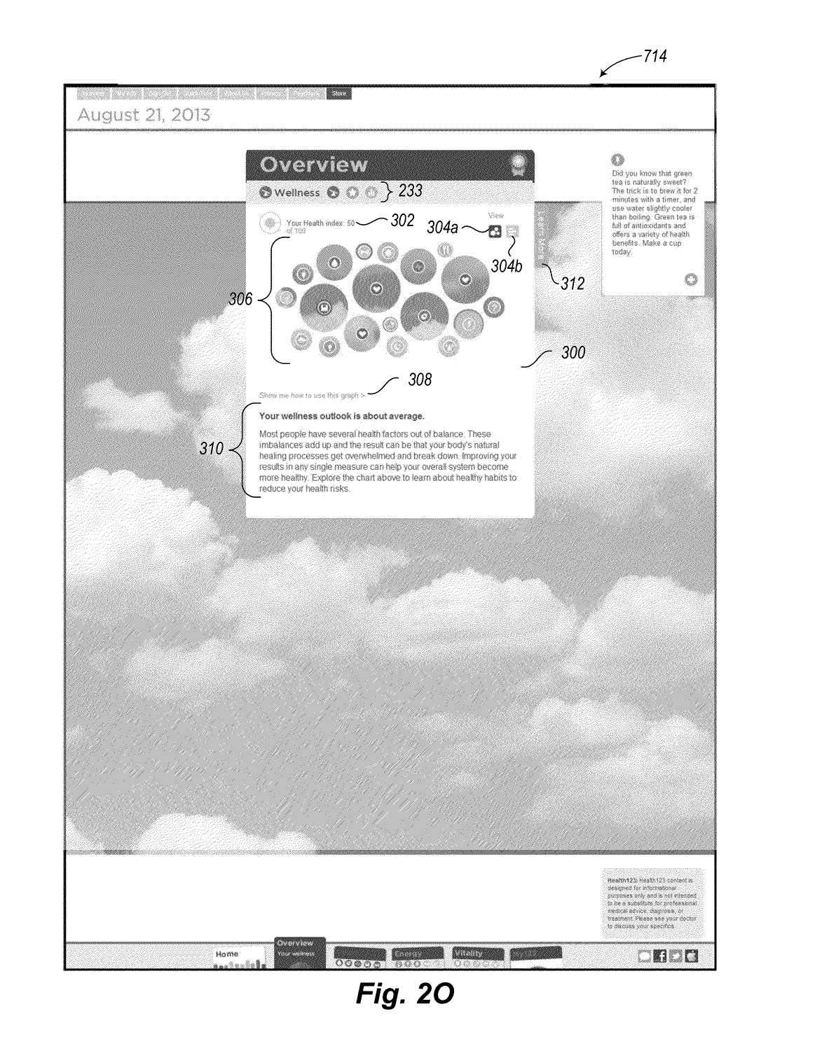

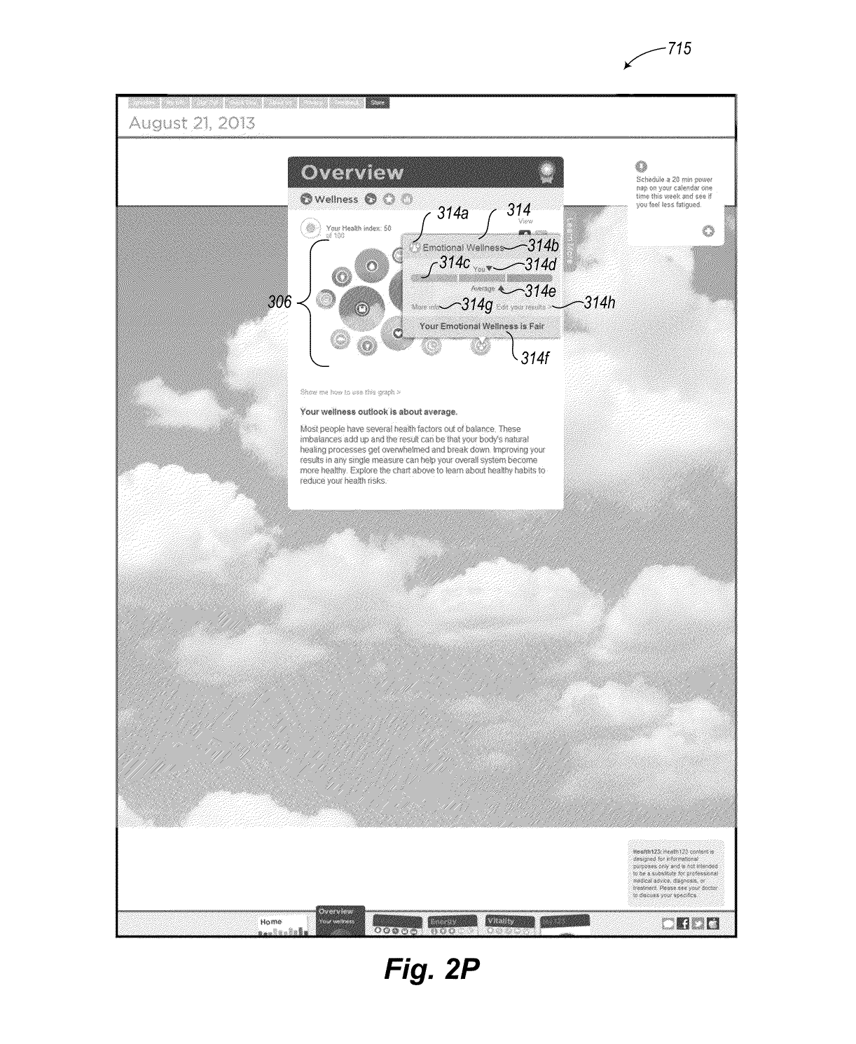

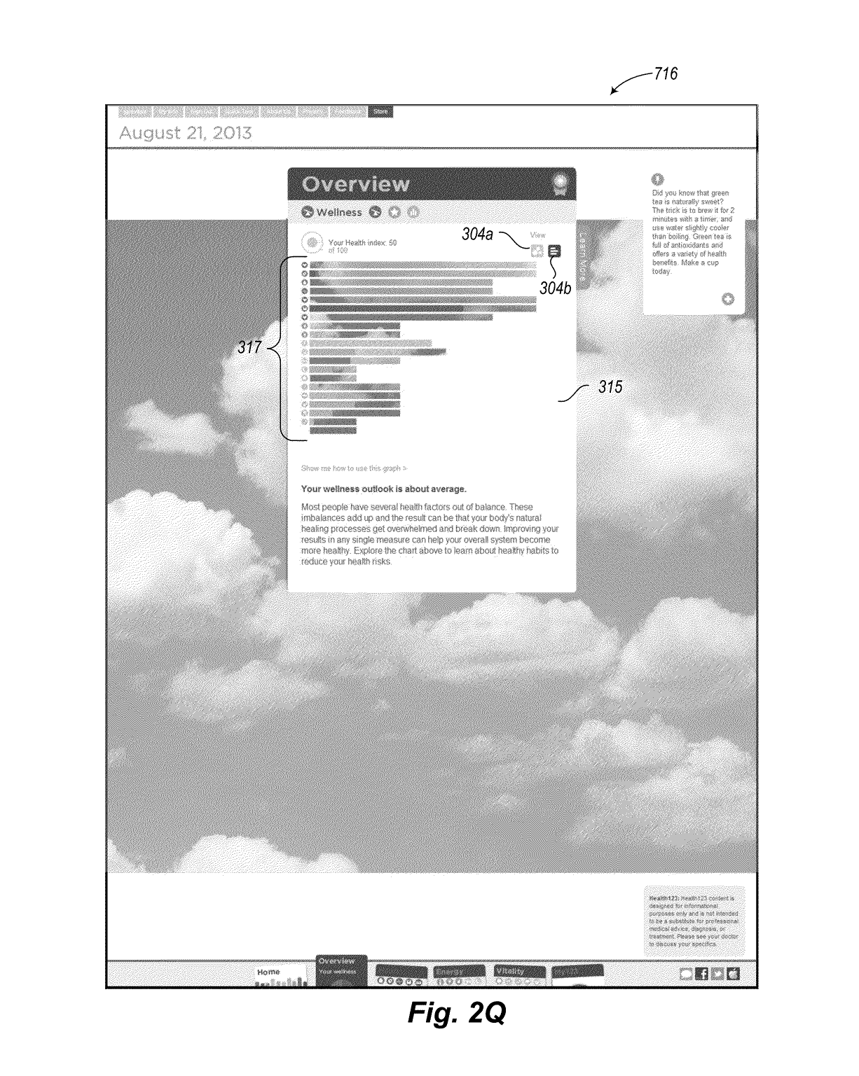

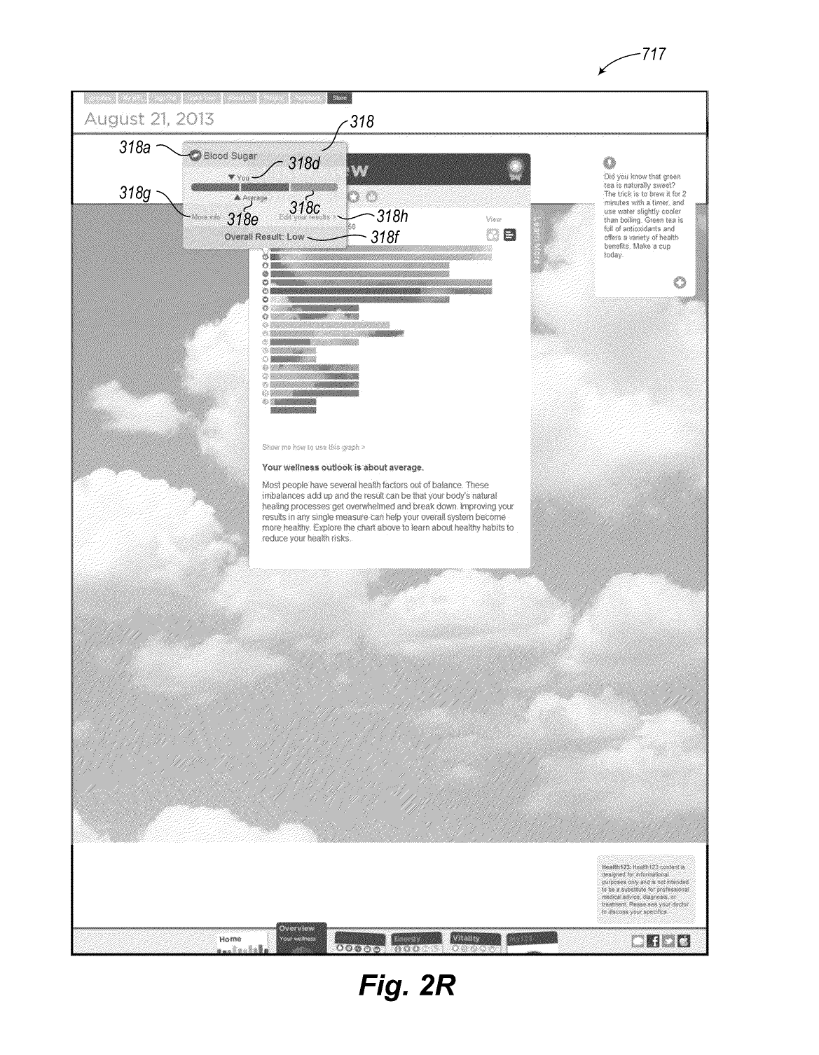

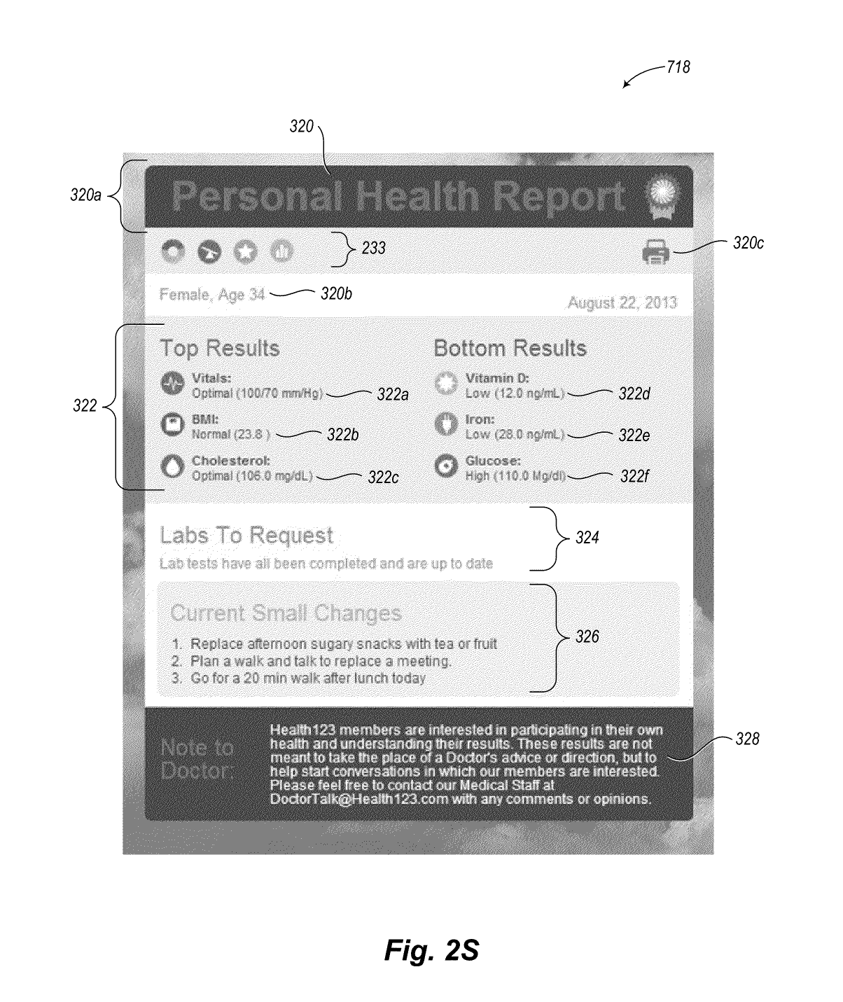

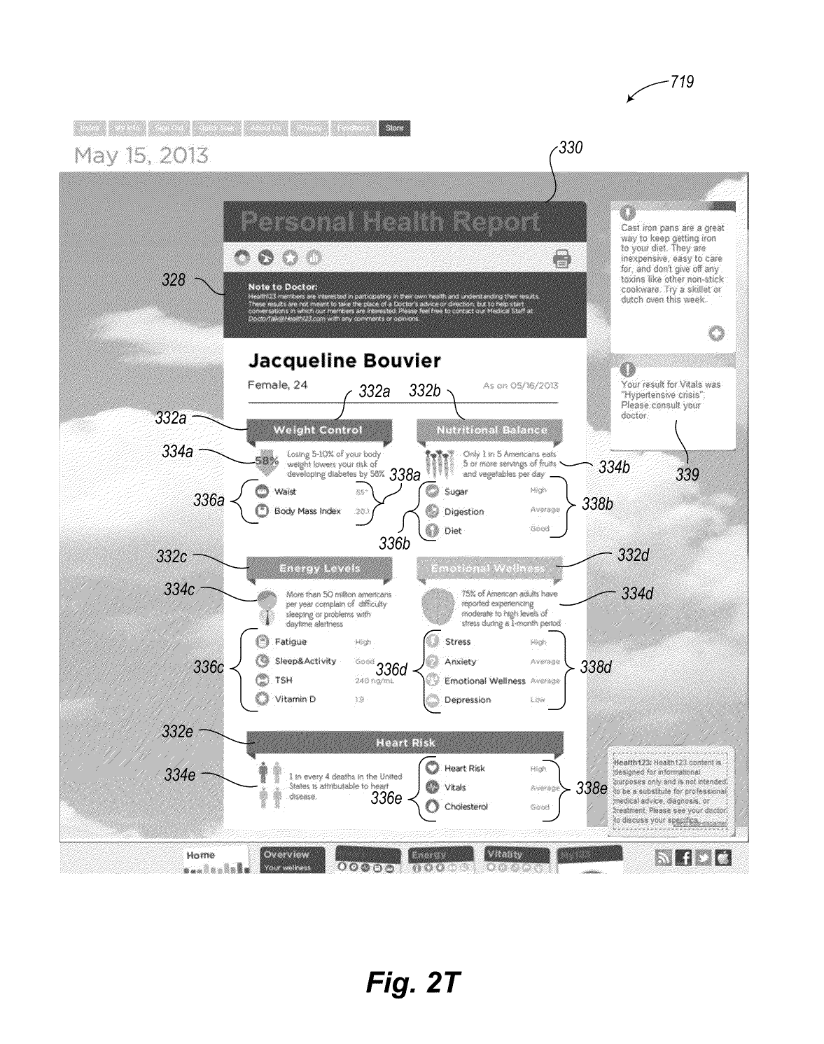

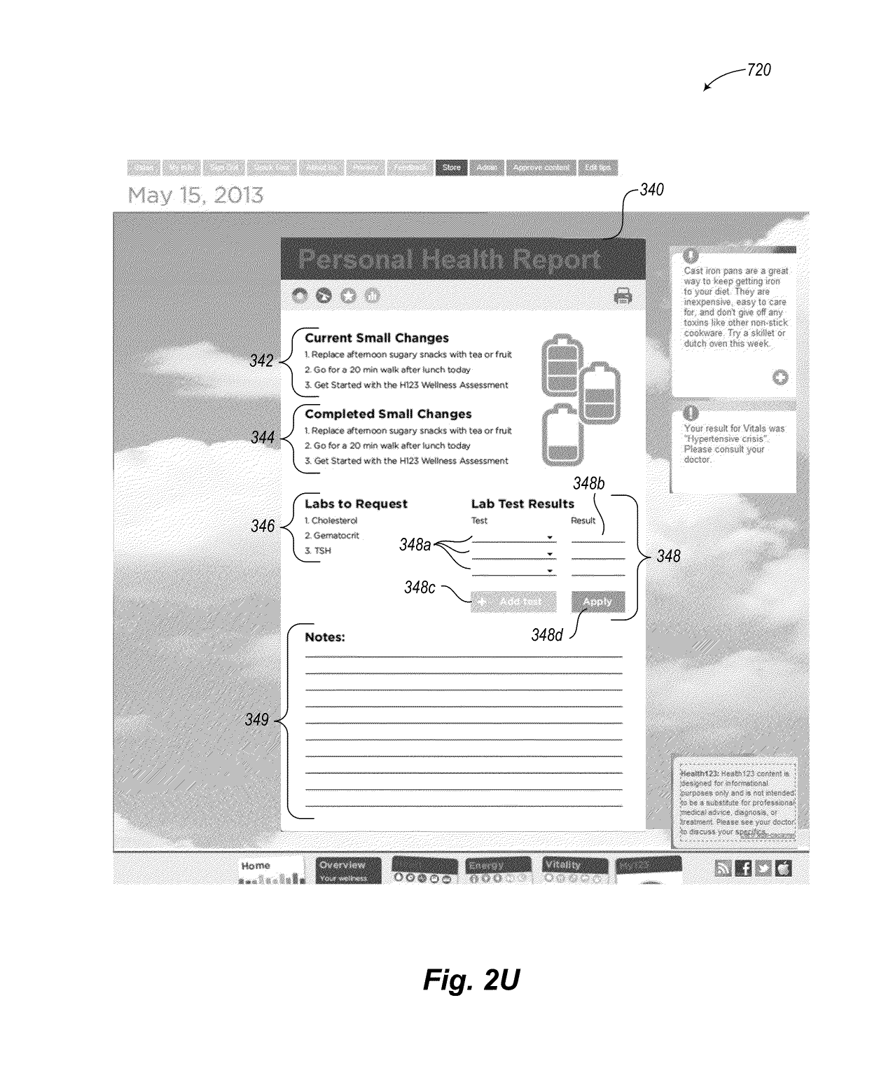

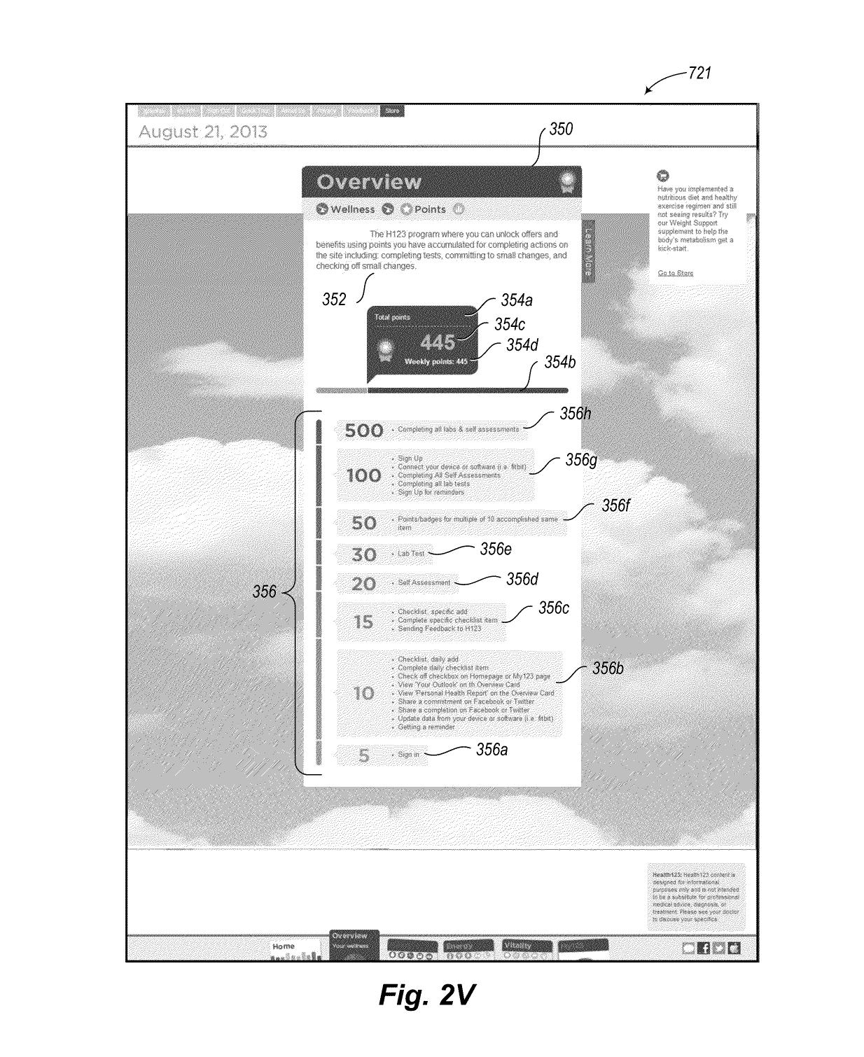

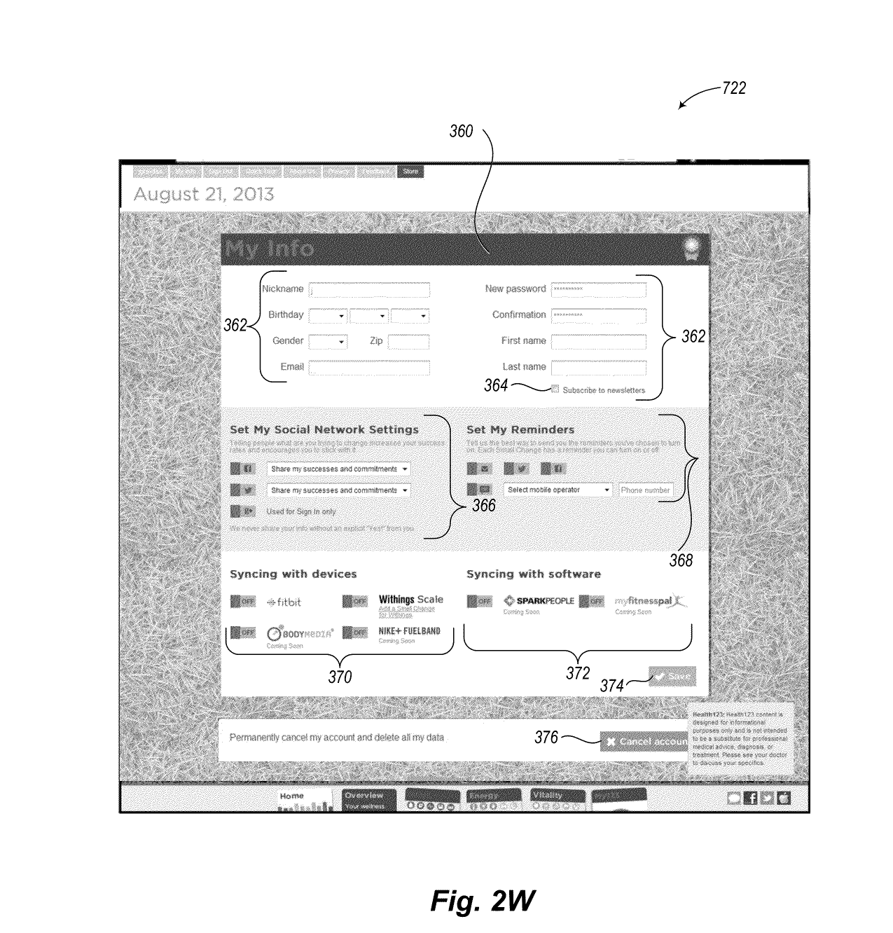

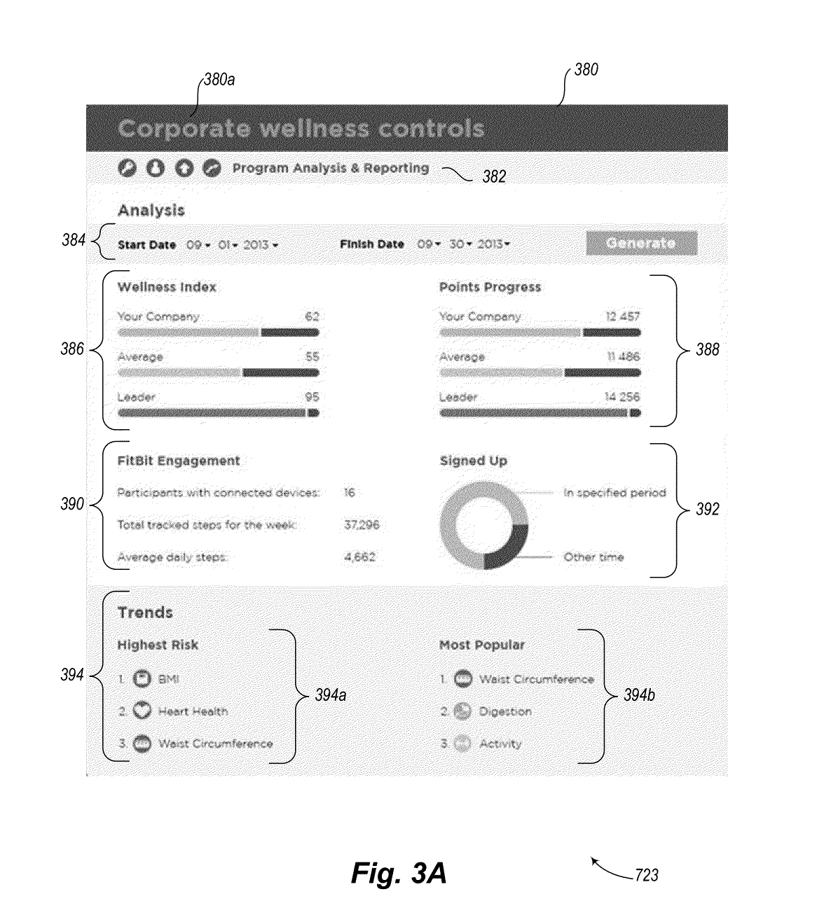

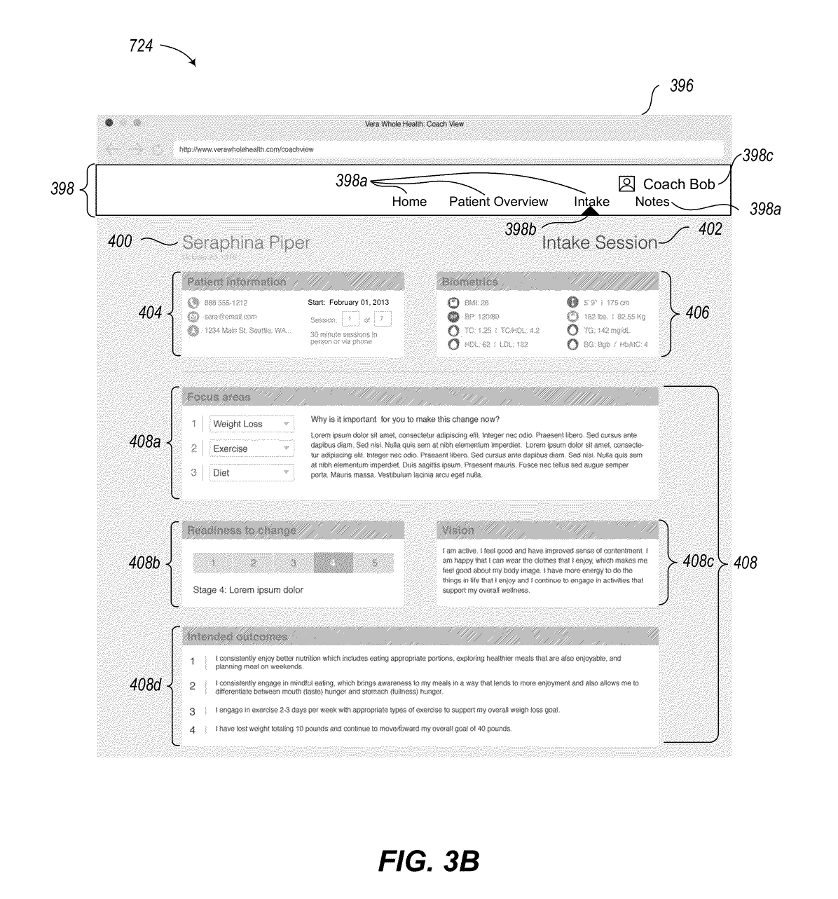

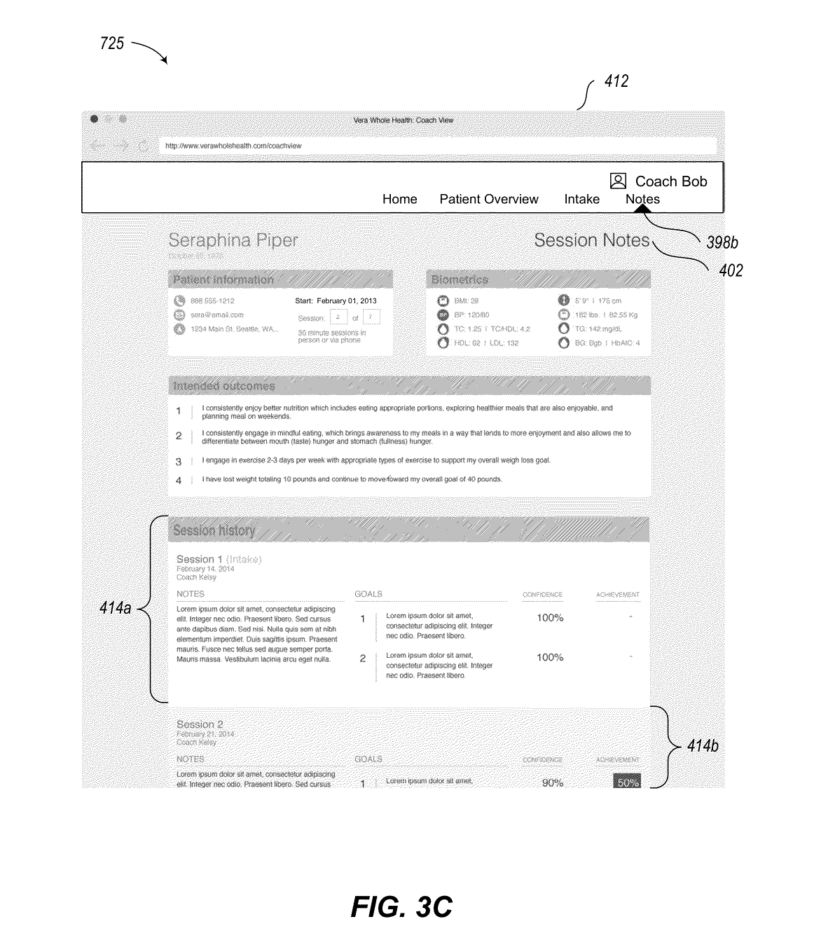

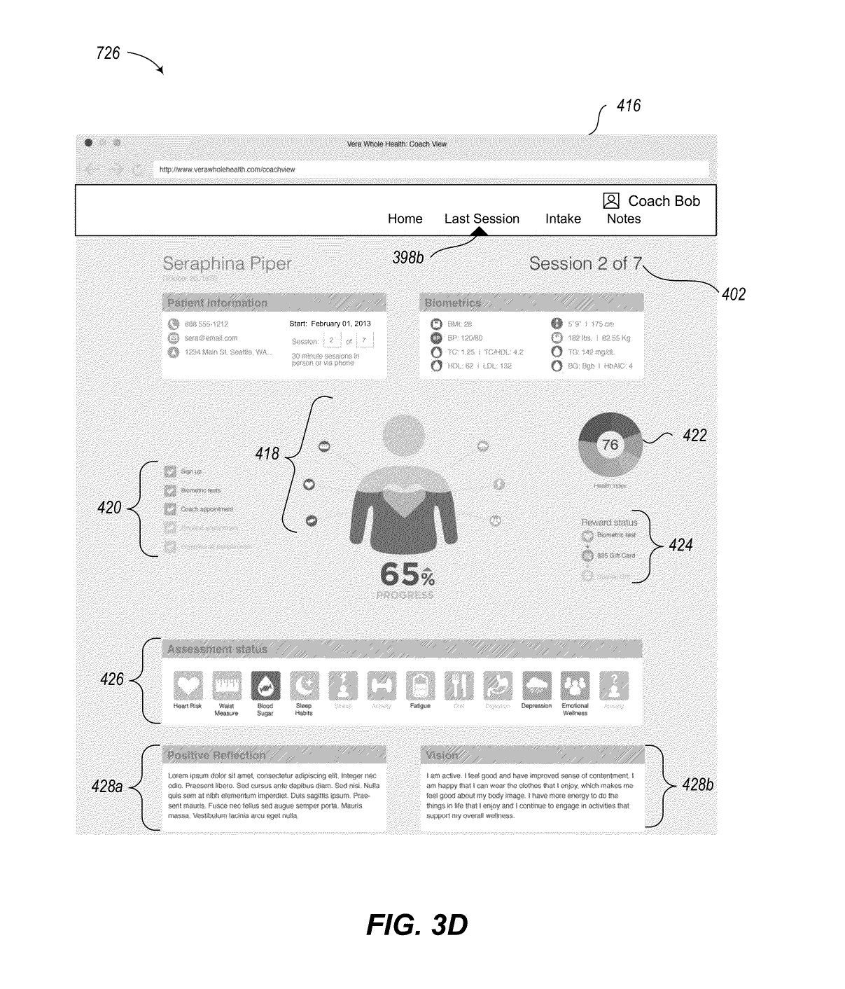

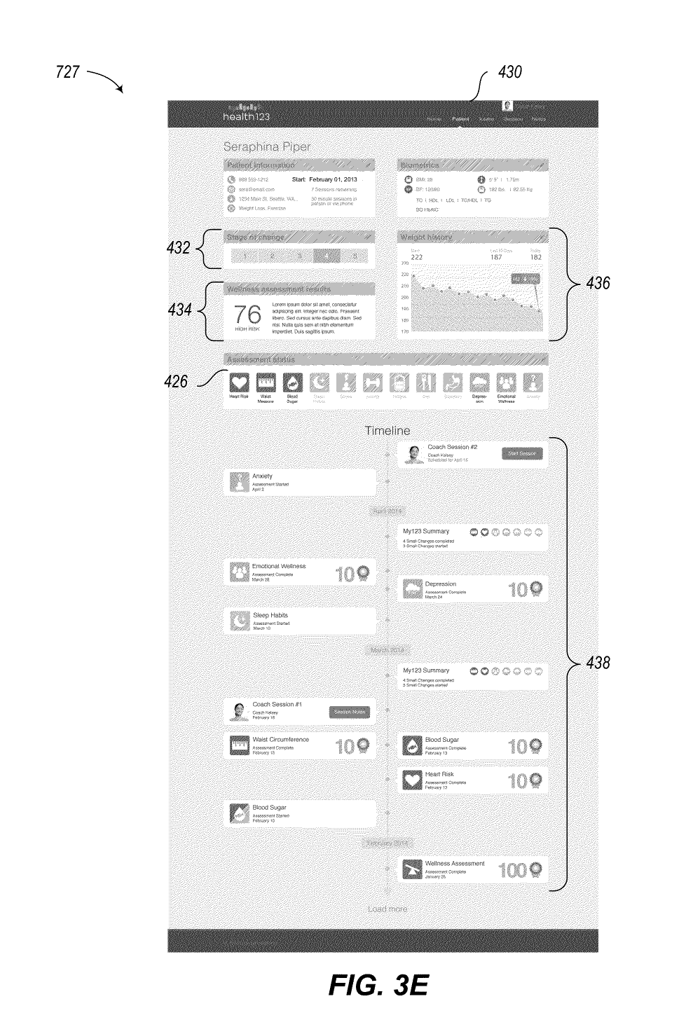

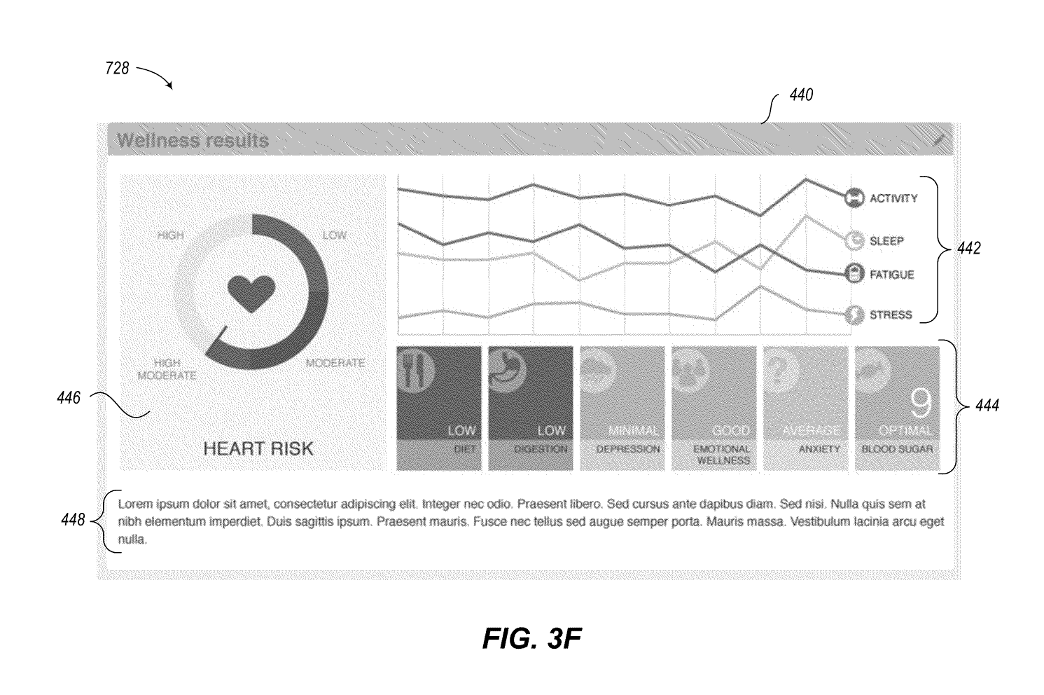

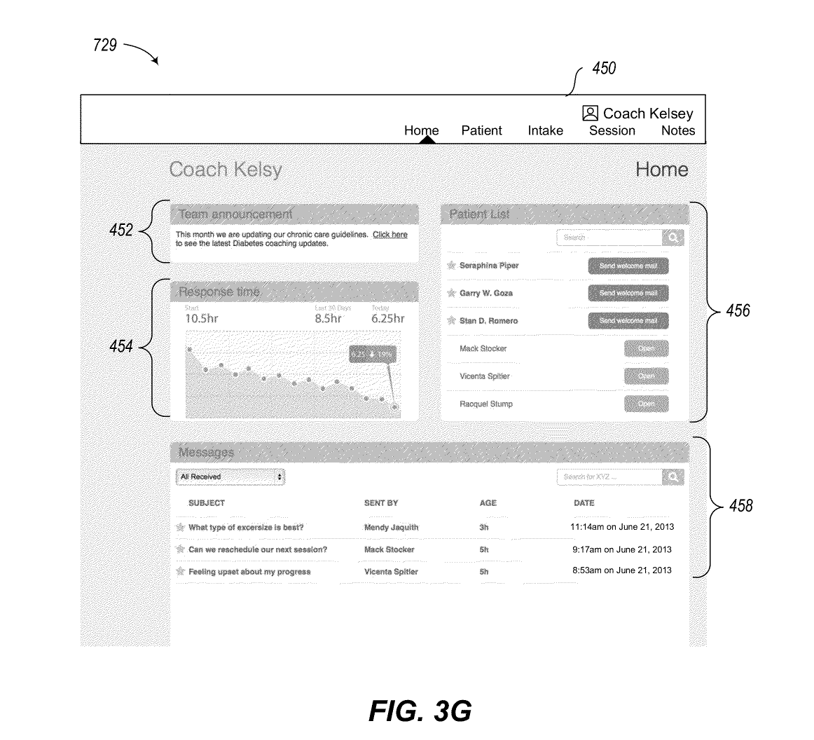

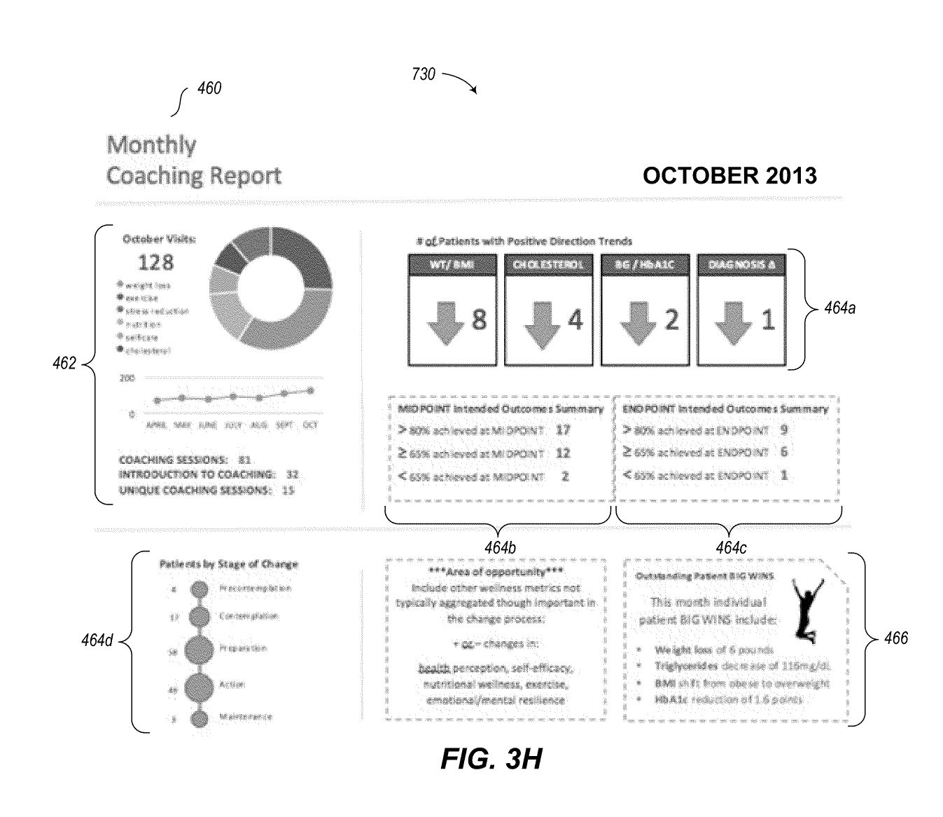

Various example graphical user interface (“GUI”) screens for the WIA system will now be presented with respect to particular embodiments shown for illustrative purposes, although it will be appreciated that other embodiments may include more and/or less information, and that various types of illustrated information may be replaced with other information. In particular, FIGS. 2A-2W and FIG. 3 illustrate examples of providing and receiving various functionality with respect to wellness information related to member users and client users of the WIA system.

FIG. 2A illustrates a GUI 700 of a main entry page that allows a user to access and interact with an example embodiment of the Wellness Information Analysis (“WIA”) system that is providing a WIA Web site—in this example, the main entry page is one of multiple Web pages of the WIA Web site. A main toolbar 200 includes a WIA system “Sign Up” control 200a, allowing a user to initiate the creation of a member user account on the WIA system; a “Sign In” control 200b, allowing a user to access that user's existing account using the corresponding login credentials; and an informational “About Us” control 200c, allowing a user to view details related to the WIA system and WIA system Web site. The GUI 700 also includes an indication of the current date 208; welcome text 202; sign-up control 204, presenting functionality similar to that described above with respect to the “Sign Up” control 200a; login control 206, presenting functionality similar to that described above with respect to the “Sign In” control 200b, and overview presentation material 210, providing the user with a brief overview of some functionality provided by the WIA Web site. In the depicted embodiment, the GUI 700 of the main entry page additionally presents a display area 212, such as may be used by one or more entities providing the WIA system to display an introductory logo or other identifying mark to users of the WIA system Web site; in certain embodiments, the display area 212 may be used to display various affiliations or credentials associated with the WIA system, the WIA system Web site, or one or more entities operating the WIA system.

FIG. 2B shows screen 701, depicting an account creation dialog 214, such as may be presented to a user of the WIA system Web site upon selecting the “Sign Up” control 200a or sign-up control 204 of FIG. 2A. The account creation dialog 214 includes user login creation controls 216, allowing a user to enter an identifying username (e.g., an email address or other identifier to be uniquely associated with a user account of the WIA system) and associated password; sign-up selection control 218; sign-in selection control 220, providing functionality similar to that described above with respect to the “Sign In” controls 200b and 206 of FIG. 2A; alternative sign-in selection controls 222, that in certain situations may be used by a user to login to the WIA system using alternative credentials (such as credentials from one of various social networking sites that support such validation); Terms and Conditions link 224, allowing a user to review those prerequisite terms and conditions required of the user in order to use the WIA system; and sign-up cancellation control 226, allowing a user to cancel the sign-up process and hide the account creation dialog 214, effectively returning the user to GUI 700 of the main entry page as depicted in FIG. 1A.

FIG. 2C shows an initial assessment screen 702, which may be displayed, for example, once a user has created an account in the WIA system using account creation dialog 214. The initial assessment screen 702 includes the main toolbar 200, which now includes an account information “My Info” control 200d, allowing the user to review various details related to his or her account within the WIA system; a “Sign Out” control 200e, allowing the user to log out of the WIA system; a “Quick Tour” control 200f, such as may allow the user to view various overview information related to functionality provided by the WIA website; the informational “About Us” control 200c, as described above with respect to FIG. 2A; policy viewing control (“Privacy”) 200g, allowing the user to view one or more privacy policies associated with usage of the WIA system and/or WIA Web site; feedback control 200h, allowing the user to provide comments regarding the WIA Web site; marketplace access control (“Store”) 200i, allowing the user to access a portion of the WIA Web site for purchasing various products and/or services from an entity operating the WIA system and/or one or more partners of such entity; and a user identification indicator 200j, indicating the username of the individual member user currently accessing the WIA system via the WIA Web site. In certain embodiments, user identification indicator 200j may provide additional functionality when selected by the user, such as displaying to the user a “home page” that may be associated with that particular user in the WIA system, one or more configuration dialogs or interfaces, etc.

The initial assessment screen 702 of FIG. 2C also includes site navigation toolbar 230, providing the user with navigation controls related to various wellness categories presented in the depicted embodiment of the WIA Web site. In the illustrated embodiment, site navigation toolbar 230 displays a card-based interface that includes a “Home” card control 230a, allowing the user to view the user's home page; an “Overview” card control 230b, which in the current initial assessment screen 702 is positioned in a raised manner to indicate that it is currently selected; “Heart,” “Energy,” and “Vitality” card controls 230c, 230d and 230e, respectively corresponding to high-level categories of wellness information; and additional reporting control 230f, which may provide access to additional reports and functionality of the WIA Web site other than those associated with the other card controls in site navigation toolbar 230. The “Overview” card control 230b, currently indicated as selected, may in certain situations provide access to various general wellness information particular to the user, such as various wellness status reports described elsewhere herein; because the current user account (“jgravitas”) has not yet completed an initial assessment, however, the illustrated embodiment of FIG. 2C, the selected status of the “Overview” card control 230b indicates that such an initial assessment is currently in progress.

Initial assessment screen 702 further includes assessment panel 232, which provides various information to the user while posing a particular query related to an aspect of that user's wellness. In particular, the assessment panel 232 includes a category title display 232a; a category display bar 233 that includes a subcategory title display 232b and a subcategory indicator icon 232c; an assessment query (“How would you rate your overall health?”) 232d; and assessment response selection controls 232e. The assessment response selection controls associated with the current assessment query comprise four distinct multiple-choice options (“Excellent,” “Good,” “Not bad/ok,” and “Poor,” respectively); as described in greater detail below, other assessment queries may be associated with various other types of assessment response options, and various embodiments may utilize other manners of collecting information related to a user's wellness from the user, either by use of assessment queries or in some other appropriate manner.

Initial assessment screen 702 also includes a wellness tip panel 234, presenting the user with a minor recommendation or brief wellness information related to one or more wellness categories; social media controls 236, which may in certain embodiments provide various functionality related to one or more social media sites; and system rewards view control 238, allowing the user to view various information related to one or more rewards allocated to the user based on the user's interactions with the WIA system and/or other activities. In certain embodiments, for example, the WIA system may provide “points” or other rewards when the user accomplishes one or more activities recommended by the WIA system in order to improve the user's wellness in one or more categories; the user may select the system rewards view control 238 in order to view such “points” currently allocated to the user, and possible rewards that may be redeemed via use of such points, either from the entity operating the WIA system or other entity. Selecting one of the social media controls 236 may allow the user to “share” or otherwise send various information presented by the WIA Web site to one or more other users of a social media Web site associated with the selected social media control.

In the illustrated embodiment, wellness tip panel 234 includes tip information 234a and tip panel controls 234b-c, allowing the user to, for example, review additional information related to the current tip information 234a and/or provide an indication that the current tip information is of interest for review at a later time. In at least some embodiments, the tip information 234a may change at various times or in various areas of the WIA Web site, such as to present a wide variety of such information during the course of a particular user's usage of the Web site. In addition, the tip information may in certain embodiments be provided in relation to wellness information associated with the user, such that the tip information becomes more relevant to a particular user as additional wellness information related to that user is obtained and stored by the WIA system.

FIG. 2D presents initial wellness assessment screen 703, in which one of the response selection controls 232e of assessment panel 232 described with respect to initial assessment screen 702 and FIG. 2C has been selected by the user. In certain embodiments, various visual feedback may be provided to the user upon selection of a response selection control, and/or in response to other interactions of the user (e.g., positioning a mouse cursor or finger over the relevant response selection control, etc.). In response to the selection of the response selection control by the user, the WIA Web site may record the user's response in one of various manners, such as to store an indication of that response within member information database 162 of FIG. 1.

FIG. 2E presents initial assessment screen 704, in which the user is presented with an additional assessment query 232d (“I exercise or work physically for at least 30 minutes at a time”) as part of that user's initial wellness assessment. In addition, the assessment response selection controls 232e reflect new multiple-choice options (“Never or Rarely,” “Some Days,” “Most Days,” and “Daily,” respectively) associated with the additional assessment query.

FIG. 2F presents initial assessment screen 705, in which the user is presented with an additional assessment query 232d (“In general, what statement best characterizes your alcohol consumption?”) and a new set of associated assessment response selection controls 232e, reflecting five multiple-choice options, of which one (“2-3 per sitting”) is indicated as being currently selected by the user. In addition, the initial assessment panel 232 of initial assessment screen 705 provides the user with additional qualification information entries 232f associated, respectively, with the assessment response selection controls positioned directly above such qualification information entries. In this manner, the WIA Web site provides the user with additional information to assist the user in selecting the appropriate assessment response selection control.

In certain embodiments, the WIA Web site may provide various quantities of distinct wellness assessment queries having various types as part of a user's initial wellness assessment; furthermore, in certain embodiments, multiple such assessment queries, each associated with an appropriate variety of assessment response selection controls (and optionally, additional qualification information entries), may be displayed simultaneously or at various times to the user. However, for the sake of brevity, additional such assessment queries are not shown here.

FIG. 2G shows initial assessment screen 706, such as may be presented to the user as a final stage of the user's initial assessment by the WIA Web site. Assessment panel 232 includes a new assessment query 232d (“Great! Now, let's make sure your results are unique to your gender, age and location”) and associated drop-down assessment response controls 232e, allowing the user to provide an indication of the user's birthdate, gender and location to the WIA system. In addition, the assessment panel 232 now includes a report viewing control 232g (“Get Results”), indicating that the initial assessment is complete and allowing the user to view the results of that initial assessment.

FIG. 2H displays a wellness reporting GUI 707, providing the user with initial assessment results, such as may be generated using the information provided by the user to the WIA system in response to a set of multiple initial assessment queries similar to those described with respect to FIGS. 2D-2G. The reporting GUI 707 includes a reporting panel 240 that includes the category display bar 233; a date indicator 240a, indicating the date on which the results being reported were generated (although in certain other embodiments, the date indicator 240a may indicate the most recent date in which information included in such results was provided to the WIA system, either in lieu of or in conjunction with the report generation date); a graphical rating indicator 240b, providing a graphical indication of the user's general wellness rating with respect to the graphical rating scale 240c; a graphical average indicator 240d, providing a graphical indication of where an “average” individual demographically similar to the user might fall on that graphical rating scale (for example, an average individual within a predefined range of ages that includes the age of the user, having the same gender as the user, and/or residing within a predefined geographical distance of the user, or using some other set of criteria to determine demographic similarity); descriptive indicators 240e, providing labels (“Beginner,” Medium,” and “High”) for the visually distinguished portions of the graphical rating scale 240c; and a brief textual description 240f of the WIA system's initial overall wellness assessment of the user.

In addition to that brief textual description, in the illustrated embodiment the reporting panel 240 is positioned adjacent to information tab control 242 (“Learn More”), providing the user with a link to additional information related to the reporting panel. In addition to the reporting panel 240, GUI 707 retains the wellness tip panel 234, and additionally presents a disclaimer message 248. The reporting panel 240 further includes an “Add New” data provision control 240g, allowing the user to provide additional information relevant to the user's wellness or revise existing information stored by the WIA system with respect to the user.

In addition to the information provided by the reporting panel 240 with respect to the user's existing wellness rating, the reporting panel includes individual recommendations 244a-c. In the depicted embodiment, each of the individual recommendations 244 describes a particular change to the user's lifestyle or activities that the WIA system has determined (such as via the recommendation manager component 112 of FIG. 1) may benefit the user in one or more ways based on the wellness information stored by the WIA system that is relevant to that particular user. Each of the individual recommendations 244a-c include corresponding recommendation reminder access controls 246a-c, which enable the user to view additional controls for configuring and enabling various reminders (described in greater detail elsewhere herein) with respect to the corresponding individual recommendation. Each of individual recommendations 244b and 244c respectively include reminder notifications 245b and 245c, indicating to the user that particular reminders related to those individual recommendations have previously been configured and are currently enabled. The reporting panel 240 additionally includes a continuation control 250 (“Next”), enabling the user to proceed to additional portions of the WIA Web site.

FIG. 2I includes a subcategory assessment screen 708. As indicated within category display bar 233, the particular assessment panel 252 corresponds to a wellness category name 252a (“Heart”) and a wellness subcategory name 252b (“Heart Risk”). In the depicted embodiment, the category display bar 233 includes subcategory status identifiers 233a-g, each corresponding to one of the seven subcategories that the WIA system currently includes within the “Heart” wellness category; the wellness subcategory name 252b is positioned to the immediate right of the subcategory status identifier corresponding to “Heart Risk,” providing the user with a further indication of the current subcategory being assessed. In addition, the category display bar 233 indicates for which of the “Heart” subcategories the user has currently provided a predetermined amount of information by displaying those subcategory status identifiers in color. In the illustrated embodiment, for example, subcategory status identifier 233e is displayed using a bright color, indicating that the user has provided all necessary information relevant to the corresponding subcategory. In contrast, subcategory status identifiers 233a-d and 233f-g are displayed in gray, indicating that additional assessments related to those subcategories have not yet been completed by the user.

Additionally, in the depicted embodiment the card-based interface of the site navigation toolbar 230 provides an additional visual indication that the user is currently viewing information associated with the “Heart” category, as the “Heart” card control 230c is currently displayed in a raised position. In various embodiments, the WIA Web site may provide other visual indicia of the level of information currently stored by the WIA system with respect to the user in various wellness categories and subcategories, or provide such visual indicia to greater or lesser extents than those of the depicted embodiment of FIG. 2I. Furthermore, in various embodiments, the WIA system may determine to categorize wellness information for one or more users in various ways, such as to provide individualized categories and subcategories based on geographic, demographic or other information relevant to the user.

The assessment panel 252 of FIG. 2I includes a subcategory description 252c; assessment response selection controls 252d, providing radio-button-style controls for the user to respond to a group of queries related to the “Heart Risk” subcategory; assessment response input controls 252e, enabling the user to enter various medical test data results (respectively identified as “Systolic,” “Diastolic,” “Cholesterol,” “Hdl,” and “Ldl”); an assessment deferral control 252f (“Skip”), enabling the user to bypass or defer completing the current assessment until a later time; and a report viewing control 252g (“Get Results”), allowing the user to view one or more assessment results related to the current “Heart Risk” subcategory. In the depicted embodiment, the assessment panel 252 further includes a solicitation panel 254, inviting the user to purchase one or more products or services related to the current assessment. In the depicted embodiment, the solicitation panel 254 invites the user to initiate a transaction for acquiring test results using testing materials provided by an entity operating the WIA Web site or other entity (such as may have a partnership or affiliate agreement with such operating entity). The depicted solicitation panel 254 includes a solicitation headline 254a, solicitation information 254b, “More info” link 254c (such as may allow the user to view additional details related to the product or service being advertised for sale), and a transaction initiation control 254d (“Order Test”). In various embodiments, a variety of products and services may be advertised for sale as part of the WIA Web site, with varying degrees of association between such products and services and the areas of the WIA Web site displaying such solicitations.

FIG. 2J displays a subcategory reporting GUI 709, providing the user with assessment results related to a particular “Waist Circumference” subcategory of the “Heart” wellness category. In certain embodiments, such assessment results may be provided to the user under various circumstances, such as immediately following the completion of one or more assessments related to the subcategory, in response to user selection of one or more assessment report viewing controls in other areas of the WIA Web site, or in other situations. In a manner similar to that described with respect to subcategory assessment screen 708 of FIG. 2I, a category display bar 233 of the subcategory reporting panel 256 includes a wellness subcategory name 256b (“Waist Circumference”) and subcategory status identifiers corresponding to subcategories within the overarching “Heart” wellness category. A subcategory description 256c is positioned between the category display bar and a graphical subcategory rating indicator 256d, which provides a graphical indication of the user's wellness rating with respect to the current “Waist Circumference” subcategory.

The assessment panel 256 further includes a graphical average indicator 256e, providing a graphical indication of where an “average” individual demographically similar to the user might fall on the graphical rating scale 256f with respect to the current subcategory; descriptive indicators 256g, providing labels (“Optimal” and “Not Optimal”) for the visually distinguished portions of the graphical rating scale; scale demarcation indicator 256h, indicating a boundary (in the depicted embodiment, a numeric boundary of “41”) between the visually distinguished portions of the graphical rating scale; a textual assessment 256k, describing the user's assessment results in easily accessible terms; and data provision controls 256i and 256j, respectively allowing the user to revise existing information or provide additional information relevant to the user's wellness with respect to the current subcategory. In a manner similar to that described above with respect to the wellness reporting GUI 707 of FIG. 2H, the subcategory reporting panel 256 also includes individual recommendations 258a-c, which are respectively associated with corresponding recommendation reminder access controls 260a-c and reminder notifications 262a-c.

FIG. 2K shows a subcategory reporting GUI 710, such as may be displayed to the user upon selection of recommendation reminder access control 260a of GUI 709 in FIG. 2J. The recommendation portion of the subcategory reporting panel 256 is currently expanded, with the recommendation reminder access control 260a displaying a “-” symbol as an indication that the user may select that access control again in order to toggle the display of the recommendation goal controls 264 and recommendation reminder controls 266.

Also, currently displayed are recommendation goal controls 264, allowing the user to define how often and for what period of time the user intends to achieve the recommendation described by individual recommendation 258a (“Go for a short walk after dinner every night this week,” now highlighted); recommendation reminder controls 266, allowing the user to configure the timing of one or more reminders that may be sent to the user in relation to individual recommendation 258a in accordance with the settings of recommendation goal controls 264; and reminder controls 268a-b, which respectively enable the user to “Cancel” or “Save” any changes made using goal controls 264 and/or reminder controls 266. In the depicted embodiment, the subcategory reporting panel 256 also includes goal sharing controls 270, allowing the user to share the relevant goal (going for a short walk after dinner every night) using one or more social media sites (such as to increase the user's motivation to complete the goal in comparison to such motivation if the goal were kept confidential or otherwise unshared). In at least some embodiments, the WIA system may track user preferences that include one or more avenues for notifying the user of messages related to the WIA system, including preferred communication channels for providing goal reminders to the user. For example, in certain embodiments and situations, the WIA system may provide goal reminders to the user using one or more of email messaging, text messaging, multimedia messaging, telephone calls, notifications provided by one or more mobile applications executing on a mobile device of the user, etc. In certain embodiments, such user preferences may be set by the user in one or more configuration dialogs associated with the user's account information, and/or may be provided by the WIA system in one or more default configurations.

FIG. 2L displays GUI 711 and a wellness category summary panel 272 associated with the “Heart” wellness category, such as may be displayed to the user upon completion of one or more assessments in subcategories related to that overarching “Heart” wellness category or in other circumstances. In a manner similar to that described with respect to subcategory assessment screen 708 of FIG. 2I, the category display bar 233 includes subcategory status identifiers 233a-g, each corresponding to a single subcategory of the “Heart” wellness category. In particular, in the depicted embodiment, subcategory status identifiers 233d, 233e and 233g are displayed using one or more bright colors, providing a visual indication that the WIA system currently stores at least some information related to such subcategories, while subcategory status identifiers 233a-c and 233f remain gray, indicating that little or no information related to those indicators' corresponding subcategories are currently stored by the WIA system with respect to the current user. As noted elsewhere, in various embodiments other visual indicia regarding a user's current information may be provided by the WIA Web site. The wellness category summary panel 272 additionally includes a category description 272a and category representation symbol 272b.

In the depicted embodiment, the wellness category summary panel 272 also provides subcategory access controls 274 and data summary indicators 275. In particular, the subcategory access controls 274a-g provide a link for each of seven subcategories within the “Heart” wellness category, which in the depicted embodiment include “Cholesterol,” “Glucose,” “Titles,” “BMI,” “Waist Circumference,” “Heart Risk,” and “Blood Sugar.” By selecting a particular subcategory access control, the WIA system may, depending on whether sufficient information for that corresponding subcategory is currently stored for the user, display one or more subcategory assessment screens (such as to enable the user to provide any information missing with respect to that subcategory) or display a subcategory reporting panel associated with that corresponding subcategory (such as that described above with respect to subcategory reporting GUI 709 of FIG. 2J). Aside from the subcategory status identifiers displayed within the category display bar 233 and alongside the corresponding subcategory access controls 274, the wellness category summary panel includes data summary indicators 275a-g, providing the user with another distinct indication of particular wellness information that may still need to be provided to the WIA system in order to improve the accuracy of its assessments and recommendations with respect to particular subcategories. In particular, data summary indicators 275a-b, 275e and 275g indicate that assessments corresponding to those subcategories (“Cholesterol,” “Vitals,” “Glucose,” and “Heart Risk”) are “Not Taken,” and data summary indicator 275f indicates that the “BMI” subcategory “Needs Attention,” such as may be displayed if the user has provided partial information for one or more assessments related to that particular subcategory. In the depicted embodiment, the subcategory access controls corresponding to the “Waist Circumference” and “Blood Sugar” are displayed without associated data summary indicators, indicating (in accordance with the colored state of corresponding subcategory status identifiers 233e and 233g) that the information for those subcategories is complete.

While FIGS. 2I-2L are particularly related to a single wellness category (“Heart”), such figures only exemplify various types of interfaces and informational elements that may be provided by one or more embodiments of the WIA system and WIA Web site related to particular categories and subcategories of wellness information. It will be appreciated that in various embodiments, the WIA system may provide these and other types of assessments and information related to a variety of additional wellness categories and associated subcategories, although for the sake of brevity a limited number of such interfaces and informational elements are presented herein. Furthermore, it will be appreciated that the presentation herein of one or more interfaces and informational elements related to particular categories or subcategories of information does not imply that such interfaces and informational elements are exhaustively presented with respect to those particular categories or subcategories, and that additional interfaces and informational elements may in various embodiments be provided by the WIA system and/or the WIA Web site with respect to those same categories and subcategories.

FIG. 2M partially displays a GUI 712 that includes a wellness category summary panel 282 associated with the “Vitality” wellness category, such as may be displayed to the user upon completion of one or more assessments in subcategories related to that wellness category or in other circumstances. In a manner similar to that described above with respect to the wellness category summary panel 272 of FIG. 2L, the “Vitality” wellness category summary panel 282 includes a category description 282a, a category representation symbol 282b, and subcategory access controls 284. In particular, the subcategory access controls 284a-g provide a link for each of six subcategories within the “Vitality” wellness category, which in the depicted embodiment include “Vitamin D,” “Depression,” “Emotional Wellness,” “Digestion,” “Diet,” and “Anxiety.” As described above, selecting a particular subcategory access control may allow the user, depending on whether sufficient information for that corresponding subcategory is currently stored by the WIA system, to display one or more subcategory assessment screens or to display a subcategory reporting panel associated with the selected subcategory. A data summary indicator 285a (“Needs Attention”) is displayed adjacent to the subcategory access control 284a (“Vitamin D”), indicating that additional information related to that subcategory may still need to be provided to the WIA system in order to improve the accuracy of its assessments and recommendations with respect to that particular subcategory.

FIG. 2N partially displays a GUI 713 that includes a wellness category summary panel 292 associated with the “Energy” wellness category, such as may be displayed to the user upon completion of one or more assessments in subcategories related to that wellness category or in other circumstances. In a manner similar to that described above with respect to the wellness category summary panels 272 and 282 respectively of FIGS. 2L and 2M, the “Energy” wellness category summary panel 292 includes a category description 292a, a category representation symbol 292b, and subcategory access controls 294. In particular, the subcategory access controls 294a-g provide a link for each of six subcategories within the “Energy” wellness category, which in the depicted embodiment include “TSH” (Thyroid Stimulating Hormone), “Iron,” “Sleep Habits,” “Stress,” “Activity,” and “Fatigue.” As described above, each subcategory access control may in various circumstances allow the user to display one or more assessment screens or reporting panels associated with the subcategory corresponding to the selected subcategory access control. In the depicted embodiment, data summary indicators 295b-c (“Needs Attention”) are respectively displayed adjacent to the subcategory access controls 294b (“Iron”) and 294c (“Sleep Habits”), indicating that additional information related to those subcategories may still need to be provided to the WIA system in order to improve the accuracy of its assessments and recommendations with respect to those particular subcategories.

FIG. 2O presents a wellness overview reporting GUI 714, providing an overview of the user's wellness according to the information currently stored for that user in a particular embodiment of the WIA system. In the depicted embodiment, wellness subcategories are presented to the user in a constellation display, with each subcategory corresponding to one circle having a relative size within the constellation such that the size of the circle is inversely proportional to the user's relative wellness score for that subcategory. That is to say, in the depicted embodiment, the lower the user's wellness score in a subcategory, the more predominant that subcategory will be within the constellation display, such as to draw the user's attention to those wellness subcategories for which changes to the user's lifestyle and/or activities may be most helpful.

The wellness reporting GUI 714 displays wellness reporting panel 300, which includes the category display bar 233; a textual health index indicator 302, providing a numerical health index score for the user's overall wellness (which in the illustrated embodiment is reported as being “50 of 100”); graphical viewing controls 304a and 304b, allowing the user to select from between different available styles of graphical data presentation; a graphical data display 306, currently depicting the various subcategories as a constellation display in the manner described above; and informational link 308 (“Show me how to use this graph”), providing the user with an opportunity to view additional information related to the graphical data display 306; explanatory wellness text 310, providing a textual assessment of the user's overall wellness as currently interpreted by the WIA system. In addition, the wellness reporting panel 300 is positioned adjacent to information tab control 312 (“Learn More”), providing the user with a link to additional information related to the reporting panel.

FIG. 2P presents a wellness reporting GUI 715, such as may be displayed to the user upon various interactions with the graphical data display 306 of FIG. 2O. In particular, in this example the reporting GUI 715 includes a variety of additional information related to the “Emotional Wellness” wellness subcategory, displayed using a subcategory overlay card 314 in a manner that overlaps with and overlays the wellness reporting panel 300 previously described with respect to FIG. 2O. Such a display of this and other additional information may be initiated or controlled in various manners in various embodiments, including based on JavaScript that is included with the Web page and that initiates the display of subcategory overlay card 314 under specified criteria (e.g., the current user interacting with the WIA Web site in a particular manner, such as initiating the movement of a mouse cursor, finger or other user-controlled indicator to a position associated with a particular region of the graphical data display 306). It will be appreciated that the details of the display of the subcategory overlay card 314 are provided for illustrative purposes only, and that in other embodiments such information may be displayed by the WIA Web site in other manners, such as in other locations of the current Web page, without overlapping and/or overlaying other information of the current Web page, in a separate frame or other display portion of the current Web page, in a separate pop-up window or other separate display area that is associated with but not part of the Web page, being initiated or controlled in a manner other than using JavaScript (e.g., via HTLM5, cascading style sheets, Adobe Flash, Ajax, Dynamic HTML, by dynamically modifying the content of the Web page, etc.), etc. In addition, it will be appreciated that various additional user-selectable controls may be provided to enable the user to modify how and/or where such additional information is displayed. Similarly, the particular types of information that are displayed as part of subcategory overlay card 314 are simplified for the sake of understanding, and other types of additional information may be displayed to supplement the display of the current Web page in other embodiments.

The subcategory overlay card 314 includes a graphical subcategory indicator 314a, which in the illustrated embodiment corresponds to the subcategory status identifier that may be displayed for the “Emotional Wellness” subcategory in the category display bar 233 with respect to those assessment and/or reporting panels associated with the “Vitality” category, as in the wellness category summary panel 282 of FIG. 2M; a textual subcategory indicator 314b, displaying the title of the particular subcategory (“Emotional Wellness”) relevant to the overlay card 314; a graphical rating scale 314c, which in the current example contains three visually distinguished portions; a graphical rating indicator 314d, providing a graphical indication of the user's wellness rating with respect to the “Emotional Wellness” subcategory; a graphical average indicator 314e, providing an indication of where an “average” individual similar to the user might fall on the graphical rating scale; a textual rating summation 314f, summarizing the user's wellness rating with respect to the “Emotional Wellness” subcategory; and overlay card controls 314g (“More info”) and 314h (“Edit your results”), such as may respectively allow the user to review additional info related to the subcategory or provide/revise information stored by the WIA system for the user with respect to the “Emotional Wellness” subcategory.

FIG. 2Q presents a wellness overview reporting GUI 716, providing an overview of the user's wellness in a manner distinct from that presented by the wellness reporting GUI 714 of FIG. 2O. In particular, rather than the constellation display of FIG. 2O, in the depicted embodiment a bar graph-style display is used. Each subcategory is associated with a single horizontal bar, with the length of the bar (in a manner similar to the constellation display) corresponding to the user's wellness rating for that subcategory in an inverse manner—that is to say, the lower the user's wellness rating in a subcategory, the longer the associated horizontal bar appears. In addition, a colored portion of the subcategory's associated horizontal bar indicates the extent to which the user's information for that subcategory is complete. Such bar graph display may be displayed to the user, for example, upon selection of the graphical viewing control 304b in the wellness reporting panel 300 of FIG. 2O. The wellness reporting panel 315 of FIG. 2Q is similar to the reporting panel 300 previously described, with the graphical data display 317 (in the bar graph-style noted above) replacing the constellation configuration of graphical data display 306. In addition, the shading of the graphical viewing controls 304a and 304b provide a visual indication to the user of that replacement.

FIG. 2R presents a wellness reporting GUI 717, such as may be displayed to the user upon various interactions (such as those described above with respect to subcategory overlay card 314) with the wellness reporting panel 300 and graphical data display 317 of FIG. 2Q. In particular, in this example the reporting GUI 717 includes a variety of additional information related to the “Blood Sugar” wellness subcategory, displayed using a subcategory overlay card 318 in a manner that overlaps with and overlays the wellness reporting panel 315 previously described with respect to FIG. 2Q.

FIG. 2S partially displays a GUI 718 that includes a user wellness reporting panel 320, providing (as indicated by title display 320a) a “Personal Health Report” for the current user. The category display bar 233 provides four user-selectable alternative view controls for selecting various views of the Personal Health Report or other wellness overview information, as well as a print control 320c (allowing the user to print the Report or otherwise send the Report to one or more additional output options). The wellness reporting panel 320 also includes demographic information 320b related to the user for which the Personal Health Report is displayed; a category summary results portion 322; test results status portion 324, providing an indication of particular laboratory tests that may be needed in order to complete various wellness information that the WIA system has stored for the current user; committed activities portion 326; and a medical communication portion 328, such as to provide medical personnel with contact information in the event that the user shares the Personal Health Report with one or more treating physicians or other medical professionals. In the depicted embodiment, the category summary results portion 322 includes “Top Results” (corresponding to the “Vitals,” “BMI,” and “Cholesterol” categories) and “Bottom Results” (corresponding to the “Vitamin D,” “Iron,” and “Glucose” categories), providing the user with a numerical summary of those categories that appear to best exemplify areas where the user may need the least or most improvement, respectively. Also in the depicted embodiment, the committed activities portion 326 indicates that the user has previously committed to complete three separate activities (replacing afternoon sugary snacks, planning a ‘walk and talk’ to replace a meeting, and going for a walk after lunch), such as in response to viewing one or more recommendations provided by the WIA system.

FIG. 2T displays a wellness reporting GUI 719, such as may be displayed to the user upon selection of one of the alternative view controls in the category display bar 233 of the GUI 718 in FIG. 2S. In the depicted embodiment, a wellness alert panel 339 is displayed (such as to alert the user to emergent conditions indicated by various information provided with respect to that user's wellness), and a user wellness reporting panel 330 provides various information relevant to category displays 332a-e (respectively corresponding to “Weight Control,” “Nutritional Balance,” “Energy Levels,” “Emotional Wellness,” and “Heart Risk”). Each of the category displays includes a category tip 334, providing the user with brief information regarding the relevant category; subcategory indicators 336 (which in the current embodiment include both graphical icons and textual labels); and subcategory summary indicators 338, providing brief summary results for the relevant subcategory based on the information currently stored for the user in the WIA system. In addition, the medical communication portion 328 is included toward the top of the wellness reporting panel, in contrast to its position within the wellness reporting panel 320 of FIG. 2S. In various embodiments, these and other portions of the GUI provided by the WIA Web site may be relocated and/or reconfigured in various manners, and may in certain embodiments be omitted entirely or supplemented by other portions and information not currently depicted.

FIG. 2U displays a reporting GUI 720 that includes a user wellness reporting panel 340, such as may be displayed to the user upon selection of one of the alternative view controls in the category display bar 233 of FIGS. 2S and 2T. The wellness reporting panel includes a committed activities listing 342, indicating those activities that the user may have previously committed to completing (such as in response to one or more recommendations provided by the WIA system); a completed activities listing 344, similarly indicating such activities that the user may have already completed (also possibly in response to one or more WIA system recommendations); a laboratory test recommendation listing 346, indicating medical tests recommended by the WIA system in order to complete some or all of the user's wellness profile information; and laboratory test result portion 348, enabling the user to provide results information related to those tests listed within the laboratory test recommendation listing or other test results. In the depicted embodiment, the laboratory test results portion includes drop-down test selection controls 348a; result entry controls 348b; additional testing specification control 348c, allowing the user to specify an additional test for which the user would like to enter results aside from those tests currently appearing in the drop-down test selection controls; and the confirmation control 348d, allowing the user to finalize and store any newly provided test results entered using the laboratory test results portion of the wellness reporting panel 340. In addition, the wellness reporting panel includes a “Notes” portion 349, such as may allow the user to enter any information related to the laboratory test results.

FIG. 2V displays a system rewards reporting panel 350 of reporting GUI 721, such as may be displayed upon selection of the system rewards view control 238 of the initial assessment screen 702 in FIG. 2C and other interfaces of the WIA Web site depicted and described herein. In various embodiments, system rewards points may be redeemed by the user in order to become eligible for various benefits provided by the WIA system, one or more entities operating the WIA system, and/or one or more partner entities of the operators of the WIA system. In the illustrated embodiment, the system rewards reporting panel includes a textual program description 352, describing general information related to the particular system rewards program currently provided by the WIA system; a graphical points indicator 354a, providing a graphical indication of the user's current system reward total with respect to the graphical scale 354b; a total points display 354c; and weekly points display 354d (which in the depicted embodiment is identical to the total points accumulated by the user, possibly indicating that the user may only have been a member of the WIA system during the current week); and a system rewards scale 356. The system rewards scale provides indications of various activities which result in the allocation of system rewards points to the user, and presents activity allocation descriptions 356a-h, each of which is respectively associated with a corresponding point value assigned to one or more activities that the user may complete using the WIA system in order to earn system reward points. For example, the activity allocation description 356c indicates that the user may be allocated 15 points for completing any of three activities (“Checklist, specific add,” “Complete specific checklist item,” and “Sending Feedback to H123,” respectively). Various embodiments of the WIA system and WIA Web site may provide other system reward programs and may alter the information related to such programs accordingly, such as to associate different activities with various system rewards, to describe one or more specific offers or benefits for which the user is eligible based on a current system reward point total, a future anticipated or predicted system reward point total associated with the user, one or more benefits associated with an employer or other group with which the user is associated, etc.

FIG. 2W shows a user account GUI 722 that includes a user configuration panel 360, such as may be displayed in various circumstances, such as upon selection of user identification indicator 200j of the main toolbar 200 (as described with respect to FIG. 2C and presented in other graphical interfaces herein). In the depicted embodiment, the user configuration panel 360 includes user information entry controls 362, allowing the user to provide or update various information related to the user's account in the WIA system; a communication preference control 364; social network configuration controls 366, allowing the user to configure various options related to sharing information or activities tracked by the WIA system with one or more social networking sites used by the user; reminder configuration controls 368, allowing the user to configure various options related to how the user would like to be notified or reminded of various activities tracked by the WIA system or otherwise related to the user's wellness; device synchronization controls 370, such as may allow the user to select various compatible wellness tracking devices with which to provide activity information to the WIA system; software synchronization controls 372, such as may allow the user to select various software and/or network-accessible service providers with which to provide activity information to the WIA system; “Save” information control 374, enabling the user to save any changed information provided via the user configuration panel 360; and account deletion control 376, such as may enable the user to cancel their account and remove any information associated with the user from the WIA system.

FIG. 3A partially displays a GUI 723 that includes a corporate wellness control panel 380 for display to a client entity user. In particular, in the depicted embodiment, the corporate wellness control panel 380 includes a title display 380a (“Corporate wellness controls”); a category display bar 382, indicating that the client entity user is currently viewing a panel associated with “Program Analysis & Reporting”; date range selection controls 384, allowing the client entity user to select a period of time for which to view various analytical information related to member users associated with the client entity; and data analysis portions displaying various aggregate data related to those member users. In the illustrated embodiment, the data analysis portions currently displayed correspond to “Wellness Index” portion 386, “Points Progress” portion 388, “FitBit Engagement” portion 390, and sign-up portion 392 (“Signed Up”). In addition, the corporate wellness control panel 380 includes “Trends” portion 394, providing the client entity user with particular wellness categories and/or subcategories that may be of interest. In the embodiment of FIG. 3A, for example, such trends include those particular subcategories 394a determined by the WIA system to be of the “Highest Risk” for the aggregate population of member users associated with the client entity, as well as the “Most Popular” subcategories 394b, such as may be determined by the WIA system based on various interactions of the client entity's member users with the WIA Web site. In at least some embodiments, the WIA Web site may provide additional control panels for client entity users, such as control panels related to account management, membership administration, incentive administration for individuals and/or groups, recommendations, partnership organizations, or other additional functionality.

FIG. 3B partially displays a GUI 724 that includes a wellness coach patient intake panel 396 for display to a client entity user assigned as a wellness coach to a member user identified as Seraphina Piper. In particular, in the depicted embodiment, the wellness coach patient intake panel 396 includes a tab display control menu 398. The display control menu 398 includes tab identifiers 398a, tab selection indicator 398b, and wellness coach identifier 398c. The intake panel 396 further includes member user identifier 400, tab title 402, member user information panel 404, member user biometric information 406, and member user goal portion 408. In the depicted embodiment, the member user goal portion 408 includes focus area panel 408a, indicating that Seraphina Piper's particular goals are generally related to weight loss, exercise, and diet; flexibility panel 408b, providing an indication of Ms. Piper's assessment of her own “readiness to change”; member user vision statement 408c; and intended outcome panel 408d, containing various statements related to the focus areas presented in focus area panel 408a.

FIG. 3C partially displays a GUI 725 that includes a wellness coach session note panel 412, such as may be displayed to wellness coach Bob if he selects the “Notes” tab identifier from the display control menu 398 depicted in FIG. 3B. Accordingly, the tab selection indicator 398b and tab title 402 indicate such selection. The session note panel 412 includes session history panel 414a corresponding to “Session 1” of Ms. Piper's wellness coach history. In the depicted embodiment of GUI 725, the session history panel 414a includes information related to a session Ms. Piper conducted with another wellness coach identified in the session history panel as Coach Kelsy, such as to apprise the active user Coach Bob of such information. In addition, FIG. 3C partially displays session history panel 414b, containing information related to a subsequent session Ms. Piper conducted with Coach Kelsy.

FIG. 3D partially displays a GUI 726 that includes a wellness coach session assessment panel 416, in which the tab selection indicator 398b indicates that the information being presented is from the “Last Session,” which the tab title 402 indicates is the second of seven such sessions. The session assessment panel includes graphical assessment progress display 418, indicating that the member user Seraphina Piper has completed 65% of wellness assessments available using the WIA system and providing a gray graphical indicator for the wellness category for which assessment is not yet completed. The session assessment panel further includes wellness coach interaction graphical indicators 420, indicating that Ms. Piper has completed three of five goals related to wellness coach interaction (“Sign-up,” “Biometric tests,” and “Coach appointment”), with two additional such goals (“Physical appointment” and “Complete all assessments”) yet to be completed. In at least some embodiments, such goals may be static, personalized for individual member users, personalized with respect to individual wellness coach users, or varied by the WIA system according to other criteria. The session assessment panel additionally includes graphical health index indicator 422; graphical reward status indicators 424, indicating that Ms. Piper has earned a free “Biometric test” as well as a $25 Gift Card, but has not yet earned the “Special Gift”; graphical assessment status indicators 426, providing colored icons for completed assessments and grade icons for those assessments still to be completed by Ms. Piper; and goal statements 428a and 428b, providing qualitative statements regarding Ms. Piper's goals at the time of Session 2.

FIG. 3E partially displays a GUI 727 that includes a wellness coach timeline panel 430 related to member user Seraphina Piper. The timeline panel 430 includes progress stage panel 432; wellness assessment results panel 434; history panel 436, which is currently depicted as displaying information related to the weight of the member user, but which in at least some embodiments may additionally provide graphical tracking information for any of multiple indices related to the member user; graphical assessment status indicators 426; and timeline view 438. The timeline view provides a graphical chronology for the member user Seraphina Piper, and as depicted includes a graphical indication of when Ms. Piper completed various assessments, interactions with the WIA system, and interactions with one or more wellness coaches providing her with supplemental care. While not currently depicted, as with the other graphical user interfaces presented herein, some or all of the information included by GUI 727 may be presented in other graphical interfaces (such as, for example, those presented to individual member users or other client entity users of the WIA system).

FIG. 3F displays a GUI 728 that includes a wellness graphical history panel 440 such as may be displayed to a member user or authorized client user, graphically depicting current wellness results relative to historical results for the relevant member user. In the illustrated embodiment, the wellness graphical history panel includes progress timeline indicators 442, providing a graphical indication of the member user's progress over time with respect to the wellness categories of “activity,” sleep,” “fatigue,” and “stress”; graphical category summary indicators 444, providing a graphical summary of the relative status of the member user with respect to various wellness categories; category display panel 446, providing a graphical indication of the member user's relative status with respect to a single selected wellness category of “heart risk”; and categorical description 448, providing context for the member user with respect to the selected “heart risk” category.

FIG. 3G partially displays a GUI 729 that includes a wellness coach home panel 450 for a client user (“Coach Kelsy”) designated as wellness coach for multiple member users of the WIA system. The wellness coach home panel 450 includes an announcement panel 452, providing Coach Kelsy with announcements from the associated client entity; coach efficacy tracking panel 454, which in the illustrated embodiment currently depicts Coach Kelsy's historical average response time to communications from and related to those member users for which Coach Kelsy acts as wellness coach, but which in at least some embodiments may provide a similar historical view of multiple other efficacy metrics related to wellness coach performance; patient list 456, depicting a listing of those individual member users assigned to Coach Kelsy and respective patient selection controls for those member users; and communications panel 458, in which various communications related to those assigned member users and other users of the WIA system are displayed.

FIG. 3H displays a GUI 730 that includes a monthly coaching report panel 460, such as may be displayed to a client user acting as a wellness coach for multiple member users of the WIA system. The report panel includes visitation graphical analysis 462, indicating that the active wellness coach user had 128 visits from assigned member users in October 2013, along with a color-coded proportional indication of particular wellness categories to which those visits were related, a graphical timeline of historical quantities of similar visits that the wellness coach conducted in the previous six months, and a breakdown of those October visits according to three types (81 “coaching sessions,” 32 “introduction to coaching” sessions, and 15 “unique coaching sessions”). The report panel also includes aggregate relative progress indicators 464a and aggregate progress analytic panels 464b, 464c and 464d, providing various statistical analyses of progress made by those member users under the care of the active wellness coach user; and announcement panels 466.

It will be appreciated that the GUIs, display screens and other information presented with respect to FIGS. 2A-2W and FIGS. 3A-3H are included for illustrative purposes, and that such information and/or other information and associated functionality may be presented or otherwise provided in other manners in other embodiments. In addition, it will be appreciated that GUIs and other information presented to users may vary with the type of client device used by the user, such as to present less information and/or functionality via client devices with smaller display screens and/or less ability to present information to or obtain input from the user, such as under control of a mobile application of the WIA system interface executing on the client device, or otherwise based on information sent to the client device from the WIA system.

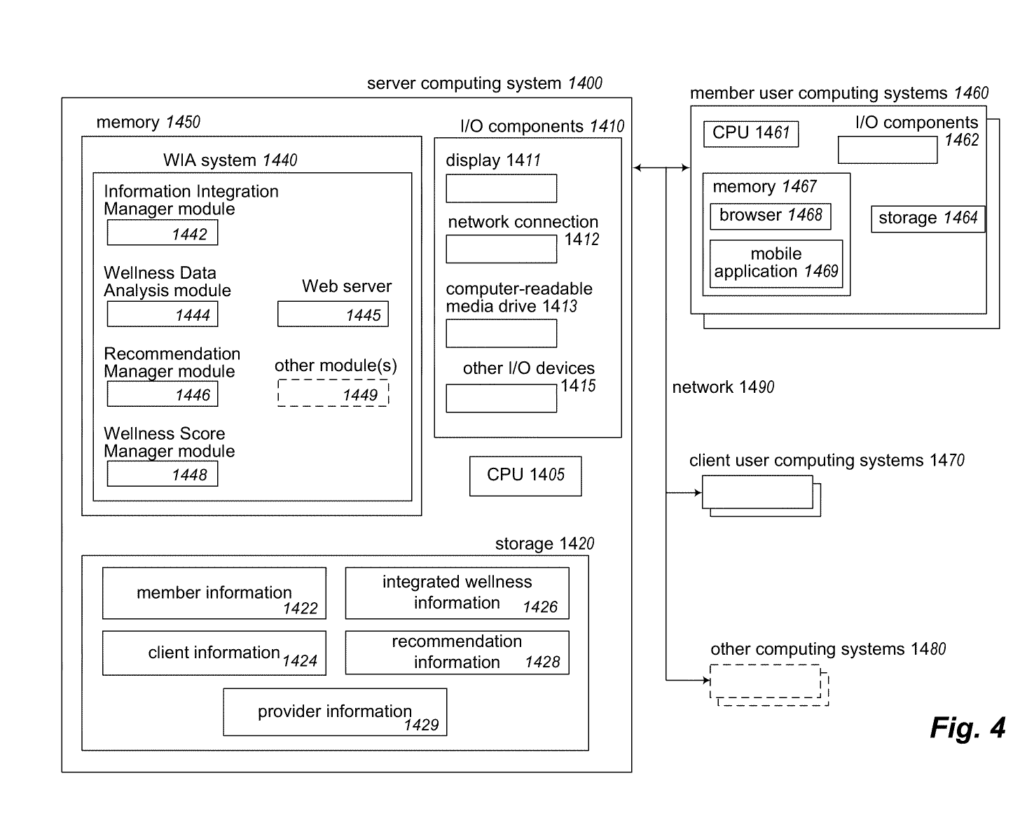

FIG. 4 is a block diagram illustrating an embodiment of a server computing system 1400 that is suitable for performing at least some of the described techniques, such as by executing an embodiment of a WIA system. The computing system 1400 includes one or more central processing units (“CPU”) or other processors 1405, various input/output (“I/O”) components 1410, storage 1420, and memory 1450, with the illustrated I/O components including a display 1411, a network connection 1412, a computer-readable media drive 1413, and other I/O devices 1415 (e.g., keyboards, mice or other pointing devices, microphones, speakers, GPS receivers, etc.). The server computing system 1400 and WIA system 1440 may communicate with other computing systems via one or more networks 1490 (e.g., the Internet, one or more cellular telephone networks, etc.), such as member user computing systems 1460, client user computing systems 1470, and other computing systems 1480. Some or all of the other computing systems may similarly include some or all of the types of components illustrated for server computing system 1400 (e.g., to have a WIA system client application 1469 executing in memory 1467 of a member user computing system 1460 in a manner analogous to WIA system 1440 in memory 1450).

In the illustrated embodiment, an embodiment of the WIA system 1440 executes in memory 1450 in order to perform at least some of the described techniques, such as by using the processor(s) 1405 to execute software instructions of the system 1440 in a manner that configures the processor(s) 1405 and computing system 1400 to perform automated operations that implement those described techniques. As part of such automated operations, the system 1440 and/or other optional programs or modules 1449 executing in memory 1430 may store and/or retrieve various types of data, including in the example database data structures of storage 1420. In this example, the data used may include various types of member user information in database (“DB”) 1422, various types of client user information in DB 1424, various types of wellness information in DB 1426, various types of recommendation information in DB 1428, various types of provider information in DB 1429, and/or various types of other information, such as various demographic or statistical information related to one or more users or markets of the WIA system.

It will be appreciated that computing system 1400 and devices 1460 and 1470 are merely illustrative and are not intended to limit the scope of the present invention. The systems and/or devices may instead each include multiple interacting computing systems or devices, and may be connected to other devices that are not specifically illustrated, including through one or more networks such as the Internet, via the Web, or via private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable and other fitness tracking devices, biometric monitoring devices, digital music player devices, handheld gaming devices, PDAs, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated WIA system 1440 may in some embodiments be distributed in various modules. Similarly, in some embodiments, some of the functionality of the WIA system 1440 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the WIA system 1440 and/or WIA client software executing on devices 1460 and/or 1470) and/or data structures, such as by execution of software instructions of the one or more software programs and/or by storage of such software instructions and/or data structures. Furthermore, in some embodiments, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

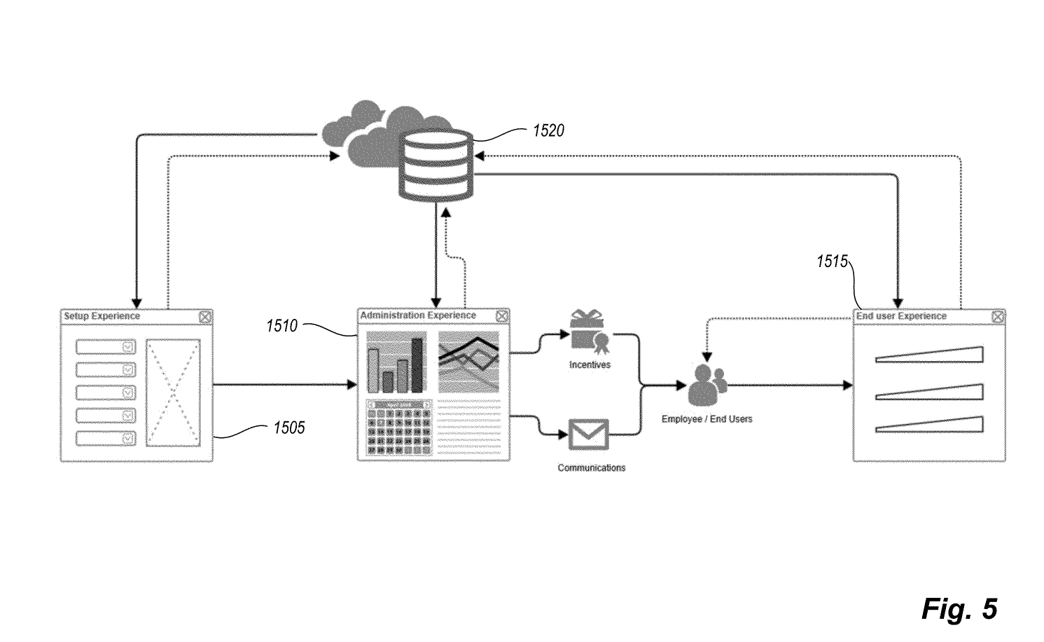

FIG. 5 is a schematic diagram illustrating an overview of various particular operations according to an embodiment of a WIA system. A first collection of interfaces 1505 provide a setup experience and functionality for one or more administrative users associated with a client entity to configure particular future interactions of the client entity with the WIA system. Such administrative users may also utilize an additional collection of interfaces 1510 (e.g., once initial configuration using interfaces 1505 is completed, or in certain embodiments prior to such completion) to access various administration functions during continued operation of the WIA system and subsequent interactions with the client entity and/or member users associated with that client entity. An additional collection of interfaces 1515 provides an end-user experience, such as for member users of the WIA system associated with the client entity or with non-administrative client entity users of the WIA system, and may include various interfaces described above with respect to FIGS. 2A-2W FIGS. 3A-3H, as well as additional interfaces providing additional functionality. Data storage 1520 provides data storage and retrieval functionality in a manner similar to that described above with respect to storage components 160 of FIG. 1.

In various embodiments, setup experience interfaces 1505 may provide functionality for initially configuring various parameters of the WIA system for use by administrative and/or member users associated with the client entity; for providing the WIA system with entity-specific criteria related to WIA system operations; for providing the WIA system with various demographic information related to the client entity and/or member users associated with the client entity; for configuring various templates or other data structures to be used by the WIA system when interacting with the client entity and/or member users associated with the client entity; configuring various communications to be used by the WIA system in conjunction with the client entity and/or member users associated with the client entity; etc. Entity demographics data, configuration data and other information may be provided to the data storage 1520 via the setup experience interfaces 1505, while such interfaces may utilize various information retrieved from the data storage 1520 during initial configuration or at other times. For example, various aspects of the setup experience interfaces 1505 may depend on demographic information and/or analytics regarding population groups related to demographic information specific to the client entity, such that global demographic information or a subset of such information may influence various setup parameters based on demographic information specific to the client entity.

Administrative interfaces 1510 may provide functionality that includes, in at least some embodiments, additional configuration of the WIA system with respect to the client entity; providing one or more “dashboard” displays for presentation of various information related to the client entity and its member users; configuration and execution of various automated reporting functions; configuration and presentation of various multi-user recommendations; configuration and presentation of various communications related to the client entity and its member users; etc. In addition, administration interfaces 1510 may facilitate updates to information stored in data storage 1520 related to company demographics, configuration settings, and member users of the client entity. Information retrieved from data storage 1520 may be used by the WIA system to configure the administrative interfaces 1510 in various ways.

In at least some embodiments, various segments of the WIA system functionality and interfaces may be separately provided to and incorporated within systems operated by one or more third-party entities. For example, initial wellness assessments and related functionality for creating initial records for member users may be provided to a third-party client entity separately from the WIA system, such that the third-party client entity may use such functionality of the WIA system to attract prospective members to that third-party client entity.

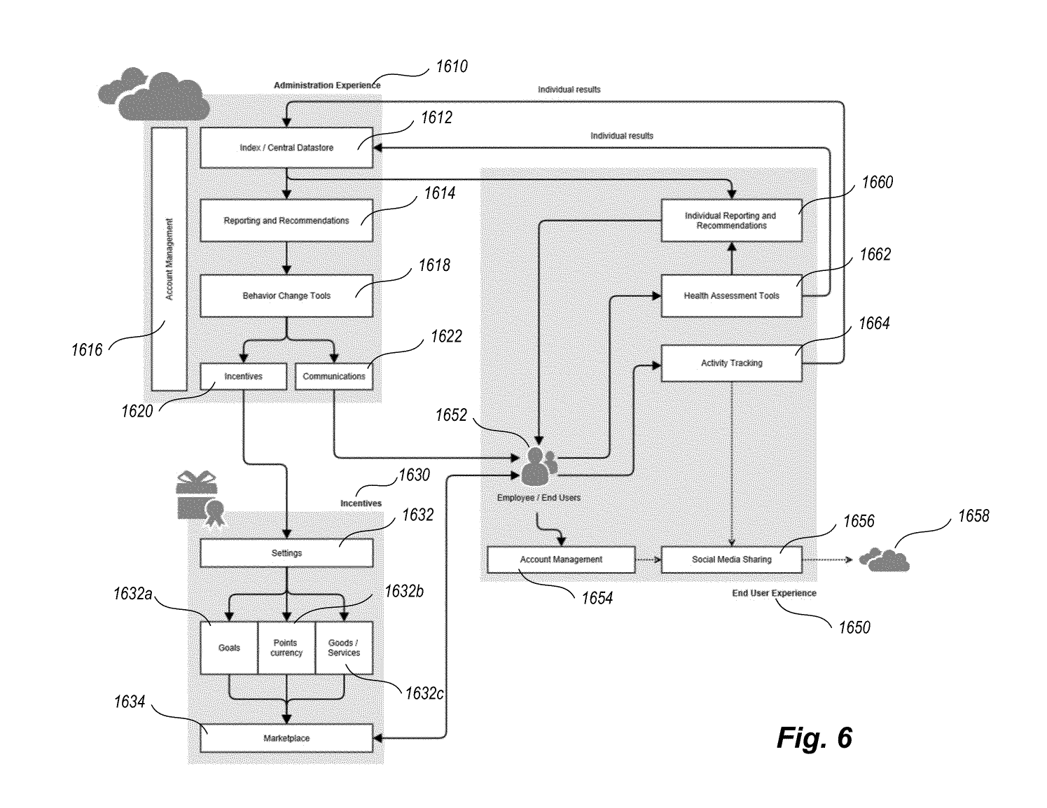

FIG. 6 is a schematic diagram illustrating an alternative overview of various particular operations according to an embodiment of a WIA system, as described below.

An Administration Experience 1610 may provide one or more client entity administration users with functionality to provide aspects of the WIA system to member users associated with a client entity. In addition, in certain embodiments the Administration Experience may allow an operator of the WIA system to create and configure new and existing client entities of the operator of the WIA system The administration experience includes datastore operations 1612, providing data storage and retrieval functionality in a manner similar to that described above with respect to storage components 160 of FIG. 1; reporting and recommendations operations 1614, in which various parameters for particular reports and recommendations related to the client entity may be configured; account management operations 1616, in which the administration users may manage the accounts of client entity users as well as individual member users associated with the particular client entity, and behavior change tools 1618, by which the administrative users may configure various aspects of the WIA system related to particular assessments or activities of its associated member users. The administration experience 1610 further includes incentives operations, allowing the administration users to configure various aspects of particular incentives/rewards created or supported by the particular client entity, and providing a portal to Incentives 1630; and communications operations 1622, allowing the administrative users to configure aesthetic and substantive parameters for communications with member users associated with the client entity. For example, communications operations 1622 may, in certain embodiments, allow a client entity to configure various parameters related to colors and branding for an instance of a WIA Web site directly associated with the client entity, such that member users of the WIA system may believe all interactions with the WIA system and Web site occur via the client entity rather than via third-party operator of the WIA system.

Incentives 1630 includes settings operations 1632, which may in certain embodiments allow administrative users to create and configure operations related to incentives, rewards, and promotional agreements for client entities of the WIA system with one or more operators of the WIA system and/or partner entities, as described in greater detail elsewhere herein. Such incentives settings may comprise information and configuration parameters related to goals 1632a, reward points and currency 1632b, and goods/services 1632c. In addition, Incentives 1630 includes marketplace operations 1634, in which various information and parameters regarding partner entities of the WIA system may be stored and/or configured.

End User Experience 1650 includes interfaces and functionality for employees/end users 1652. In the depicted embodiment, the End User Experience includes account management operations 1654, in which member users may provide personal individual information (e.g., physical and/or electronic contact information), account authorization credentials, and communications preferences. In addition, the End User Experience includes social media sharing operations, allowing a member user to configure preferences related to those activities to be shared via one or more of the user's social media services 1658. The End User Experience also includes individual reporting and recommendations operations 1660, health assessment tools 1662, and activity tracking operations 1664, all of which are described in greater detail elsewhere herein.

Those skilled in the art will appreciate that the Web pages and other data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A computer-implemented method, comprising:
receiving, by one or more computing systems configured to provide a wellness information analysis service, information related to a wellness of a user from one or more of a plurality of data sources associated with the user;
generating, by the one or more configured computing systems, a wellness rating for the user, the generating of the wellness rating including applying one or more weighting factors to the received information;
providing to the user, by the one or more configured computing systems, an indication of the generated wellness rating and one or more recommendations for improving the wellness of the user, the one or more recommendations being based at least in part on at least some of the received information;
after the providing of the one or more recommendations, receiving, by the one or more configured computing systems, additional information related to the wellness of the user from at least one of the plurality of data sources associated with the user; and
generating, by the one or more configured computing systems and based at least in part on the additional information, a modified wellness rating for the user.

2. The computer-implemented method of claim 1 wherein the method is performed for each of a plurality of users associated with a single entity.

3. The computer-implemented method of claim 2 wherein, for each of at least some of the plurality of associated users, receiving the information related to the wellness of the user includes receiving information from the single entity.

4. The computer-implemented method of claim 3 wherein, for one of the at least some of the associated users, generating the wellness rating includes applying at least one of the one or more weighting factors to the information received from the single entity.

5. The computer-implemented method of claim 2 wherein providing the one or more recommendations includes generating at least one recommendation to improve an aggregate wellness of at least some of the plurality of users associated with the single entity.

6. The computer-implemented method of claim 1 wherein receiving the information related to the wellness of the user includes receiving an indication of one or more interactions of the user with a graphical user interface provided by the wellness information analysis service.

7. The computer-implemented method of claim 1 wherein receiving the information related to the wellness of the user includes receiving responses from the user to one or more queries provided to the user.

8. The computer-implemented method of claim 1 wherein receiving the information related to the wellness of the user includes receiving at least one assessment of biological material from the user.

9. The computer-implemented method of claim 1 wherein receiving the information related to the wellness of the user includes receiving one or more medical records of the user.

10. The computer-implemented method of claim 1 wherein receiving the information related to the wellness of the user includes receiving at least some of the information from one or more devices of the user via a programmatic interface of the wellness information analysis service.

11. The computer-implemented method of claim 1 wherein receiving the information related to the wellness of the user includes receiving at least some of the information via a programmatic interface of the wellness information analysis service from one or more third-party services associated with the user.

12. The computer-implemented method of claim 1 wherein the user is one of multiple users, wherein the generating of the wellness rating for the one user includes applying a first set of one or more weighting factors to the information received for the one user, wherein the method further comprises generating an additional wellness rating for another of the multiple users, and wherein generating the additional wellness rating includes applying a distinct second set of weighting factors to information received for the another user.

13. The computer-implemented method of claim 1 wherein the applying of the one or more weighting factors to the received information includes applying at least one weighting factor to the received information that is based at least in part on one or more data sources that are not associated with the user.

14. The computer-implemented method of claim 13 wherein the applying of the at least one weighting factor includes applying at least one weighting factor based at least in part on one of a group that includes public demographic data, geographical data, one or more governmental databases, and one or more medical databases.

15. The computer-implemented method of claim 1 wherein generating the wellness rating for the user includes generating multiple distinct wellness ratings for the user with respect to each of multiple wellness categories.

16. The computer-implemented method of claim 1, further comprising:
generating one or more distinct additional recommendations for the user based at least in part on the received additional information, and
providing the user with one or more indications of the modified wellness rating and of the one or more additional recommendations.

17. The computer-implemented method of claim 1 wherein the received additional information includes an indication that the user has taken one or more actions subsequent to the providing of the one or more recommendations, and wherein the method further comprises providing a reward to the user based at least in part on the one or more actions taken by the user.

18. The computer-implemented method of claim 17 wherein at least one of the one or more actions taken by the user is in accordance with at least one of the provided recommendations.

19. A wellness information analysis system, comprising:
one or more processors;
one or more first components that, when executed by at least one of the one or more processors:
for each of a plurality of respective users associated with an entity, receives information related to a respective wellness of the respective user; and
for each of the plurality of respective users, generates one or more wellness ratings associated with the respective user based at least in part on one or more weighting factors applied to the received information, wherein each of the one or more generated wellness ratings for the respective user indicates a value representative of the wellness of the respective user with respect to one or more of multiple categories; and
one or more second components that, when executed by at least one of the one or more processors:
analyzes the received information for each of the plurality of respective users, wherein the analysis of the received information includes a determination of a respective priority to assign to each of at least some of the multiple categories with respect to at least some of the plurality of respective users;
determines, based on the analysis of the received information, one or more recommendations for facilitating an aggregate improvement of a health of the plurality of users with respect to one or more of the multiple categories; and
provides one or more indications to the entity of at least one of the one or more determined recommendations.

20. The wellness information analysis system of claim 19 wherein the one or more first components, when executed by at least one of the one or more processors:
receives, after the at least one indicated recommendation is provided, additional information related to the respective wellness of at least one of the respective users;
based at least in part on the received additional information, determines one or more additional recommendations for facilitating the aggregate improvement of the health of the plurality of users; and
provides an indication to the entity of the one or more additional recommendations.

21. The wellness information analysis system of claim 19 wherein, for at least one of the respective users, the information for the respective user is received from one or more of multiple data sources associated with the respective user.

22. The wellness information analysis system of claim 21 wherein, for the at least one respective user, the multiple data sources include one or more of a client device of the user, a medical provider associated with the user, and an employer of the user.

23. The computer-implemented method of claim 19 wherein, for each of at least one of the respective users, at least one of the one or more weighting factors applied to the information for the respective user is based at least in part on data sources that are not associated with the respective user.

24. The wellness information analysis system of claim 19 wherein the one or more second components provide the indication to the entity of the at least one determined recommendation via a graphical user interface of the wellness information analysis system.

25. The wellness information analysis system of claim 19 wherein the one or more second components provide the indication to the entity of the at least one determined recommendation in a manner consistent with one or more regulatory requirements related to privacy of at least one of the respective users.
